(19) United States
(12) Patent Application Publication
(10) Pub. No.: US 2014/0257852 A1
(43) Pub. Date: Sep. 11, 2014

(54) AUTOMATED INTERACTIVE HEALTH CARE APPLICATION FOR PATIENT CARE

(71) Applicants: CLINTON COLIN GRAHAM WALKER, PETALUMA, CA (US); MARK VINCENT ORTIZ, SAN JOSE, CA (US)

(72) Inventors: CLINTON COLIN GRAHAM WALKER, PETALUMA, CA (US); MARK VINCENT ORTIZ, SAN JOSE, CA (US)

(21) Appl. No.: 14/197,298

(22) Filed: Mar. 5, 2014

Related U.S. Application Data
(60) Provisional application No. 61/772,592, filed on Mar. 5, 2013.

(51) Int. Cl. G06F 19/00

(52) U.S. Cl. CPC G06F 19/3418; G06F 19/322; G06F 19/327; G06F 19/3431
USPC 705/3

(57) ABSTRACT

Various health care services may be provided to a patient via a virtual nurse or interactive user application operating on a user computing device. One example method may include receiving a recurring user health diagnostic at a server that stores user health records from a remote user computing device that receives and updates user health diagnostic data of a user on a recurring basis. The method may also include storing the user health diagnostic in a user patient data record of the server, and generating a health diagnostic history summary based on the at least one recurring user health diagnostic and updating the user patient data record to include the health diagnostic history.

### CROSS-REFERENCE TO RELATED APPLICATION

This application claims priority to an earlier filed provisional patent application No. 61/772,592 filed on Mar. 5, 2013 and entitled “AUTOMATED HEALTH CARE APPLICATION”, the entire contents of which are hereby incorporated by reference.

### TECHNICAL FIELD OF THE APPLICATION

This application relates to assisting users with continuing health care management via a computer-based application.

### BACKGROUND OF THE INVENTION

The majority of health care providers offer services, prescriptions, treatment regiments, advice, etc., to patients on a daily basis. As patients grow older, develop chronic conditions and/or fall ill to serious health conditions, they require more frequent access to doctors, prescription medicine, hospitals, etc.

Health care systems in place today in the United States almost demand health care coverage. People who are older may be eligible for Medicare. People who cannot afford health insurance may be eligible for Medicaid. The Federal government has instituted strict programs for managing such government funded programs. For example, recent legislation has created strict limits on readmissions, or the number of times a person may visit the doctor, the hospital, etc., in a particular time frame.

As a result of stricter payment structures instituted by the Federal government, hospitals are increasingly cautious about allowing readmissions to patients, and have begun instituting programs to limit the likelihood of a patient coming back to the hospital or the clinic for further health care assistance. The number of patients who take their medicine, fill their prescriptions and have a substantial understanding of their particular condition(s) is low. Management of a patient's condition does not require constant interfacing with a doctor and may be setup and monitored via a computer-based application that a user may access and communicate with on an on-going basis.

### SUMMARY OF THE INVENTION

One example embodiment of the present application may provide a method that includes identifying a modification to a user's health care record stored in a database, identifying at least one new term included in the modification, creating a health care management record in a database responsive to the identified at least one new term, and selecting a plurality of content records to include in the user's health care management record.

Another example method of operation may include receiving user input selections from a plurality of inquiries generated to receive user input, generating at least one numerical score corresponding to each user input selection, incorporating the at least one numerical score with a user's primary health score; determining whether the user's primary health score is at least one of above or below at least one predetermined health threshold, and creating a notification alert invoking a health care action if the user's primary health score exceeds or undercuts the at least one predetermined health threshold.

Another method may include identifying at least one medical prescription currently associated with a user's health care management record, identifying an initial dosage requirement of the at least one medical prescription, generating at least one series of recurring inquiries in the user's health care management record, receiving a plurality of responses to the recurring inquires, and determining whether to create a dosage modification based on the plurality of responses.

Another example method of operation may include identifying a modification to a user's health care record stored in a database, identifying at least one new term included in the modification, parsing the at least one new term and comparing it to a predefined list of associated terms, retrieving an advertisement associated with the predefined list of associated terms which match the at least one new term, and generating a message in the user's health care record with access to the advertisement.

Another example method of operation may include receiving at least one recurring user health diagnostic at a server configured to store user health records from a remote user computing device configured to receive and update user health diagnostic data of a user on a recurring basis, storing the at least one recurring user health diagnostic in a user patient data record of the server, and generating a health diagnostic history summary based on the at least one recurring user health diagnostic and updating the user patient data record to include the health diagnostic history.

### BRIEF DESCRIPTION OF THE DRAWINGS

FIG. 1 illustrates a conventional prior art logic diagram of a user's interactions with a health care provider.

FIG. 2 illustrates an example logic diagram of a user's interactions with a health care provider, according to an example embodiment of the present application.

FIG. 3A illustrates an example patient record update and maintenance application according to example embodiments.

FIG. 3B illustrates an example patient knowledge base game plan setup and maintenance application according to example embodiments.

FIG. 3C illustrates an example prescription maintenance setup and maintenance application according to example embodiments.

FIG. 4A illustrates a flow diagram of patient health care management operations according to example embodiments.

FIG. 4B illustrates another flow diagram of patient health care management operations according to example embodiments.

FIG. 5 illustrates an example patient scoring procedure and subsequent patient update procedure according to example embodiments.

FIG. 6 illustrates an example patient vital sign update and recording procedure according to example embodiments.

FIG. 7A illustrates an example GUI of a virtual nurse avatar service of a health care service application, according to example embodiments.

FIG. 7B illustrates another example user interface of the virtual nurse application offering a care plan menu option to the user, according to example embodiments.

FIG. 8 illustrates an example content sharing function of a health care service application, according to example embodiments.

FIG. 9 illustrates an example health condition selection interface of a health care service application, according to example embodiments.

FIG. 10 illustrates an example physician selection interface of a health care service application, according to example embodiments.

FIG. 11 illustrates an example of a detailed physician selection interface of a health care service application, according to example embodiments.

FIG. 12 illustrates an example physician geographical location map of a health care service application, according to example embodiments.

FIG. 13 illustrates an example care plan selection interface of a health care service application, according to example embodiments.

FIG. 14 illustrates an example condition content selection interface of a health care service application, according to example embodiments.

FIG. 15 illustrates an example health condition information portal of a health care service application, according to example embodiments.

FIG. 16 illustrates another example health condition information portal of a health care service application, according to example embodiments.

FIG. 17 illustrates an example health condition content sharing logic diagram of a health care service application, according to example embodiments.

FIG. 18 illustrates an example system configuration according to example embodiments.

FIG. 19A illustrates a system diagram configuration of an example method of operation according to an example embodiment of the present invention.

FIG. 19B illustrates a system diagram configuration of another example method of operation according to an example embodiment of the present invention.

FIG. 19C illustrates a system diagram configuration of still another example method of operation according to an example embodiment of the present invention.

FIG. 19D illustrates a system diagram configuration of yet another example method of operation according to an example embodiment of the present invention.

FIG. 19E illustrates a system diagram configuration of still yet another example method of operation according to an example embodiment of the present invention.

FIG. 20 illustrates an example user interface screenshot of the interactive health application for a patient according to example embodiments.

FIG. 21 illustrates an example user interface screenshot of the interactive health application for a physician according to example embodiments.

FIG. 22 illustrates an example user interface screenshot of the interactive health application for an administrator according to example embodiments.

FIG. 23 illustrates an example network entity device configured to store instructions, software, and corresponding hardware for executing the same, according to example embodiments of the present application.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present invention, the invention may be applied to many types of network data, such as, packet, frame, datagram, etc. For purposes of this invention, the term “message” also includes packet, frame, datagram, and any equivalents thereof. Furthermore, while certain types of messages and signaling are depicted in exemplary embodiments of the invention, the invention is not limited to a certain type of message, and the invention is not limited to a certain type of signaling.

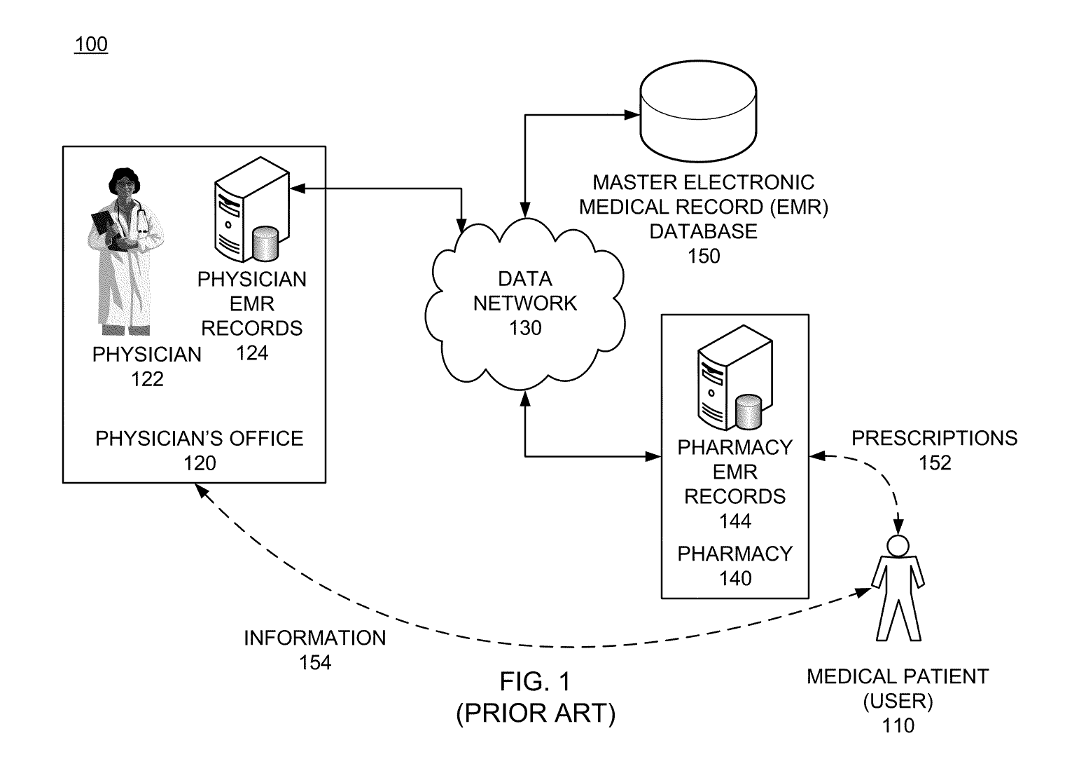

FIG. 1 illustrates a conventional prior art logic diagram of a network model of a user's interactions with a health care provider communication system. Referring to FIG. 1, in the past the network configuration 100 would include a medical patient or user 110 setting up a doctor's appointment with a physician 122 via a phone interaction or an online setup procedure. The user 110 would have a health insurance plan, a past medical record established by the health insurance provider, a pharmacy record stored in a pharmacy computing system 144 accessible via a local pharmacy 140 and/or a physician electronic medical record 124 which may or may not be integrated with the physician EMR records 124. The patient's EMR record at the doctor's office may be updated after the appointment takes place to a master EMR 150 that is maintained across a network 130 at a remote server or database 150. The records may be maintained by the physician's office 120, the insurance company, the pharmacy, etc., or a combination of each of the various medical provider entities via their various computing platforms and software registration services.

As user information 154 is obtained and stored into the user's EMR records 124, the patient 110 may likely receive a prescription 152 that is transmitted through a computer or via a phone system to the pharmacy 140. The patient 110 may bring the prescription in paper form to the pharmacy to have his or her prescription filled or refilled. In summary, a patient 110 is obligated to fill and administer his or her own prescriptions and if there are new health problems or existing health problems that will not subside, the patient must setup another appointment and wait for a response from the physician or another in-person appointment. Patient questions, problems, maintenance and most importantly documentation and determinations regarding a patient's diminishing health problems are only identified when a user dials 911, visits the doctor in-person or enters an emergency room for immediate assistance.

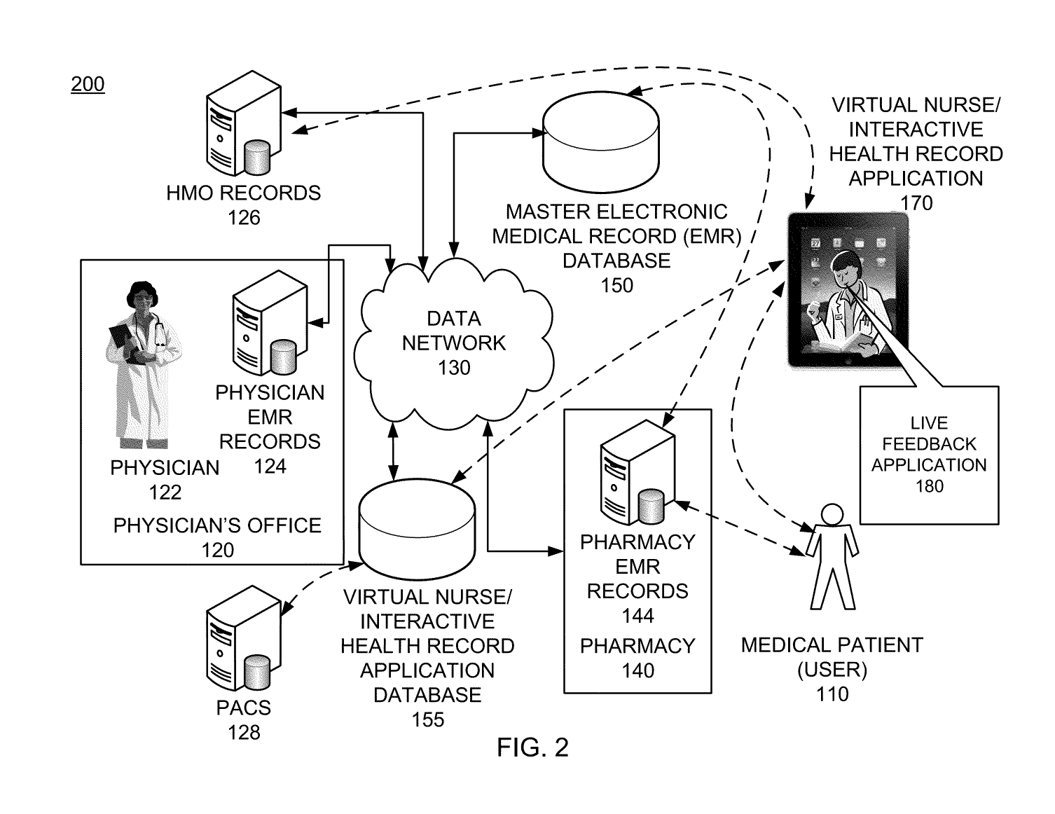

FIG. 2 illustrates an example logic diagram 200 of a user's interactions with a health care provider communication system, according to an example embodiment of the present application. Referring to FIG. 2, like reference numerals refer to like elements. In this example embodiment, the patient's prescriptions, chronic conditions, health care suggestions, requirements, etc., are all accessed from the user's personal assistance record that is either stored in a central database which is accessible via a virtual nurse application 170, or which is accessible via directly from a hospital, clinic, outpatient facility, etc. A virtual nurse or caregiver application 170 may be installed and operating on a mobile computing device (e.g., laptop, tablet, smartphone, etc.). The application may synchronize with the user's virtual nurse application database 155, which is similar to an EMR record that identifies the user, his or her latest diagnoses, prescriptions, etc. Due to HIPPA guidelines, it may be prudent to maintain a separate database 155 from the master EMR 150 both of which identify the user, his or her health conditions and one or more treatments (e.g., prescriptions, time, diagnostic analysis, etc.) The application may offer live feedback 180 to the user as a human-like digital and on-screen avatar that is demonstrating concern with keeping the user updated with their health care management plan.

FIG. 2 also illustrates the connectivity of the application database 155 to other third party data record sources including the user's picture archiving and communication system (PACS) 128 and to the user's HMO data 126 as well as the data network 130. Such database sources are in addition to the more common EMR 150 and HER data record types. This enables either physicians or patients to access those more private HIPPA-guarded data records in a read-only manner. For example, the patient application 170 may require basic knowledge of the data in the EMR, EHR, and/or imaging study records (ultrasound, PET, CT, angiography, MRI, etc.) for second opinions, etc. This also enables an important feature of the contemplated application which is to lie on top of other health record server applications such as MYHEALTHONLINE by SUTTER Health in order to provide all of the health record content of those and any other patient healthcare institution portals through the one management nurse/interactive application 170. Thus, the application of the present application becomes a consolidator of all of the patient's health records in one place with a simplified user interface.

The virtual nurse/interactive health application database 155 and other operating functions may be outsourced to the cloud as a private user database that stores the user records, responses, care-plan information customized for the user, etc. The care providers in a user's group may include a primary care physician, other specialty physicians, nurses, office assistants, physical therapists, home visiting medical professionals, vocational nurses, friends and family, etc.

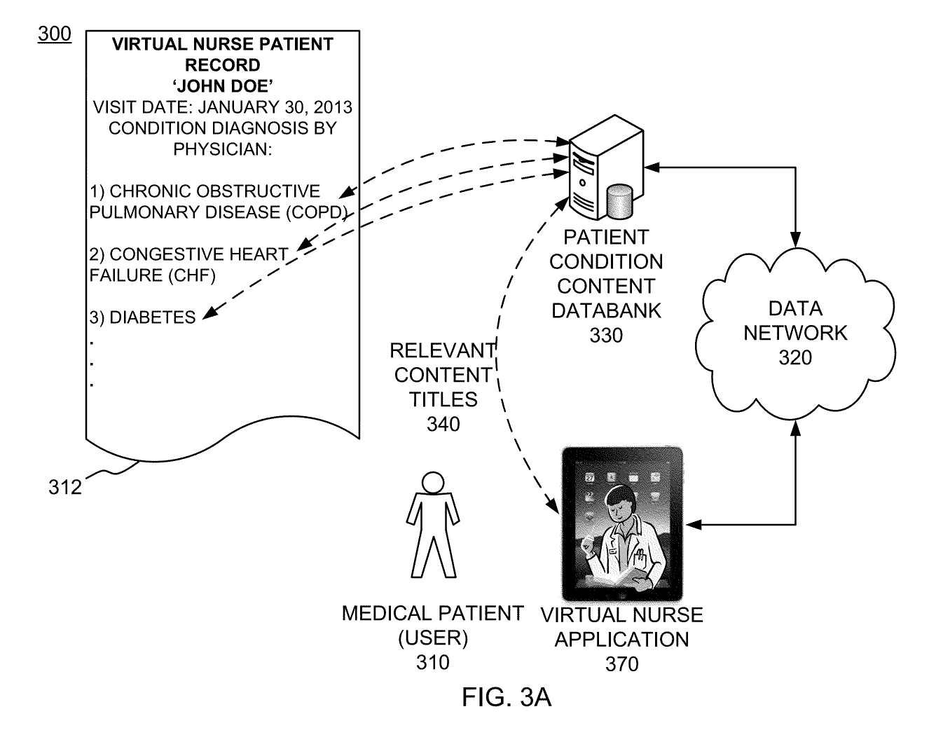

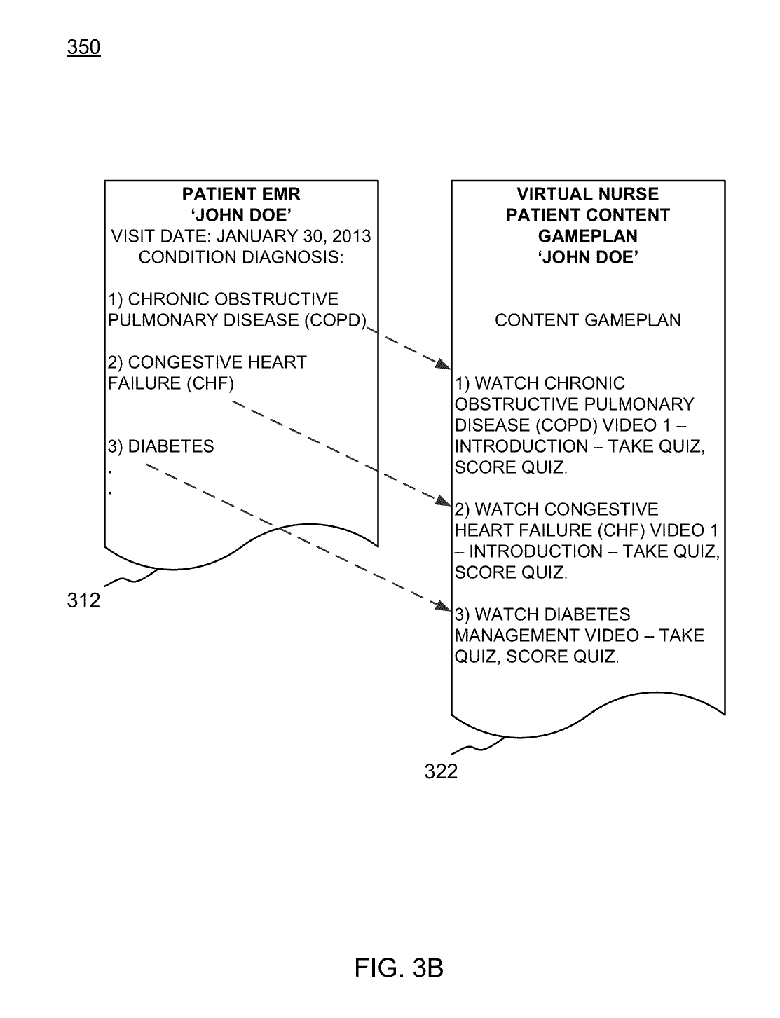

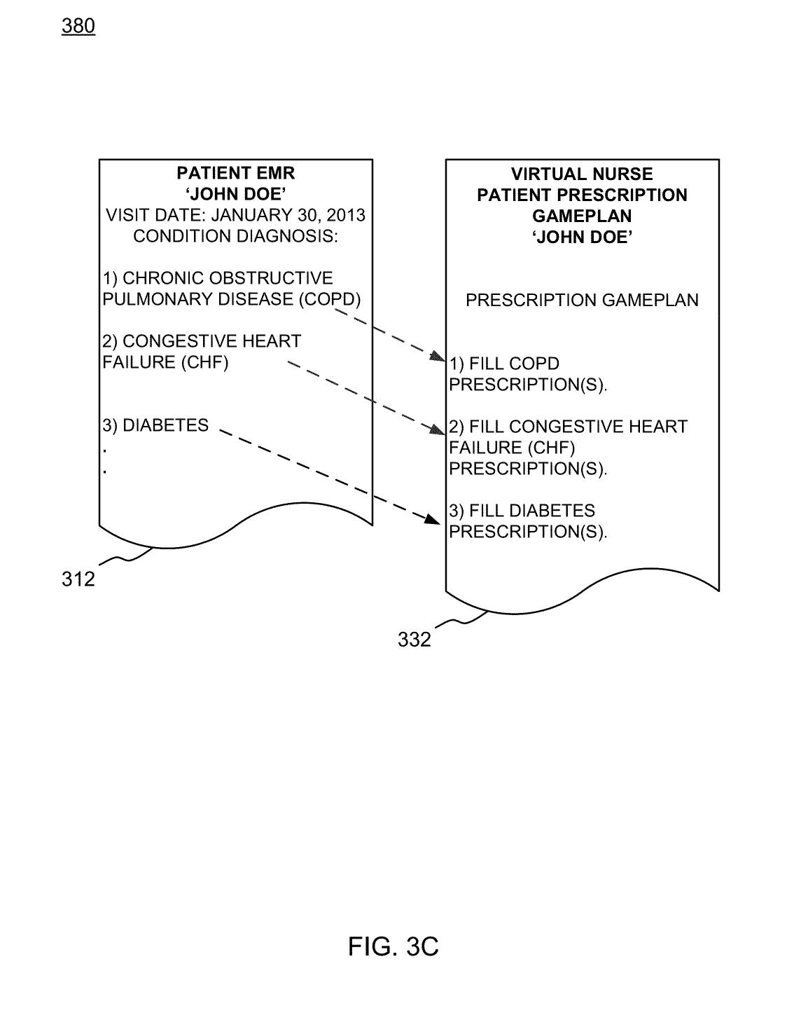

FIG. 3A illustrates an example patient record update and maintenance application 300 according to example embodiments. Referring to FIG. 3A, the user 310 may access his or her virtual nurse application 370 and observe a list of messages, tasks, etc., and elements that require feedback in order to satisfy patient chart elements and obligations. According to one example, the user 310 may be on his or her way home from the doctor's office and may have his or her care-plan generated with mandatory content that must be observed by the patient (e.g., videos, electronic brochures, drug suggestions, commercials, chapters of books, etc.) populating their virtual nurse care plan chart. As the user's chart is updated, the text in the chart that is newly added may cause an automated identification and parse operation that seeks to identify any new terms added, such as new conditions (e.g., diabetes, heart disease, congestive heart failure (CHF), chronic obstructive pulmonary disease (COPD), etc.) recently diagnosed since a previous parse operation. These health conditions are identified based on key terms related to the conditions (e.g., COPD, CHF, chronic breathing problems, chronic heart problems, smoking, blood work results (e.g., predetermined threshold levels per unit blood), age, etc. As a result, there may be a scoring algorithm used to ensure that enough data is present for the computer system to establish that the user has a chronic condition by ensuring perhaps that the blood work levels are added in a summing operation to ensure various criteria thresholds, or a function of blood work thresholds, age and prescriptions received in order to designate a user as having a particular condition.

Once a chronic condition or serious or known condition is identified by the processing application 370, a knowledge base function may select relevant content titles 340 from a database of known patient conditions 330. The titles may be chapters in electronic books, drug information brochures, videos about the condition etc. The metadata of the digital files may match the user's conditions in his or her virtual nurse profile information record. All the data may be stored in a remote third party server, in the cloud and/or in a databank of health information provided by subscription services provided to the user.

According to one example, as a user may be diagnosed with a new condition (COPD), the user may have his or her chart parsed via a grammatical or semantic parsing algorithm, the information that is extracted from the parsing algorithm may be compared by a direct correlation comparison with metadata tags stored in the content files 340, such as videos related to COPD, chapters of books relate to COPD, drugs used to treat COPD, etc. Also, other conditions which may result from or that may be related to users who have COPD (e.g., age demographic, past history, etc.), may receive information about other conditions that may arise from the likely diagnosis of the related conditions. An additional correlation operation may be performed to determine whether the user should be aware of other conditions or concerns regarding the present condition, present status (e.g., age, weight, current chronic conditions, current acute conditions). Those identified titles, videos, etc., that relate to the user's current condition COPD may be set aside in a suggested content sharing category that is unscored or unweighted with respect to the user's present care plan agenda.

All this identified relevant content information may be queued and delivered to a messaging function of the user's virtual nurse application. The virtual nurse patent chart 312 may be the basis for identifying a list of retrieved content titles that the patient 310 must watch, read or understand so he or she will be more likely to understand and care for their health. For example, 312 provides a user that has the COPD condition entered into his or her chart, the user's application list of information may be updated with videos, brochures, treatment plans, etc., on COPD. Also, the user may also receive a list of videos, chapters of books, etc., based on related conditions (e.g., shortness of breath, respiratory flare-ups, etc.). The relevant content may be delivered to the user in an email message format including links to videos and electronic books stored in a database in the cloud. Third party licensees may offer subscription services to the hospital or care giver application service to share with the patient as needed. The application is capable of extracting user conditions from the user's record(s), matching relevant educational materials and providing those materials to the user automatically in a message queue format permitting the user to open the message and identify the content one content title at a time.

FIG. 3B illustrates an example patient knowledge base health gameplan setup and maintenance application according to example embodiments. Referring to FIG. 3B, the document correlation 350 may include a patient chart ‘John Doe’ being accessed and correlated with a “todo” list for the user. For example, the condition COPD is identified by a word processing identification algorithm and a video is retrieved along with a quiz to ensure the user understands the fundamental aspects of the condition. The quiz may be scored and kept as part of the patient's overall health condition score which may be invoked to trigger a readmission if necessary to health care services at a later time. Similar results may be produced for the other health conditions CHF and Diabetes. The patient EMR 312 may be correlated to a virtual nurse patient content game-plan 322. Since EMR records are HIPPA sensitive and cannot be divulged, the algorithm may perform a live correlation or private word analysis that identifies the likely health conditions as they arise based on keyword medications, conditions, age, etc. Also, the doctor or nurse may experience a column or pop-up interface that parallels the private EMR so the conditions can be extracted, confirmed and set into a game plan content sharing effort to inform the patient about his or her condition (see FIG. 3A).

According to one example embodiment, a user may be undergoing a patient review and may be linked or diagnosed with a new medical condition whether serious or not, the condition may invoke a series of actions to be conducted with the help of the virtual nurse application. For example, one embodiment may include a method of identifying a modification to a user's health care record stored in a database, identifying at least one new term included in the modification via a parse operation or other filtering mechanism and prepare a care plan that will be associated with the user account for future treatment. The method may also include creating a health care management record in a database responsive to the identified at least one new term, the management record may be linked to literature, questions, information, future appointments and other related medical care instructions and requirements for the user to adhere to going forward in time. For example, if the term “diabetes” is identified as a new term not previously included in the patient's health records, the term may be identified and parsed based on a list of conditions that are used as the basis for an audit procedure.

In operation, the user's health record may be updated by a nurse or doctor (i.e., “patient tested positive for diabetes”). The word diabetes can be automatically parsed from the record being updated based on a list of known terms, conditions which are associated with a set of operations and/or procedures which require changes to the patient's health care plan. One example is the automated loading of data materials, quizzes, videos, audio, and other information the user would benefit from having and which could increase the patient's current health and save money and time. For example, the proper diet of a diabetic could be presented as a video to the user who may take it upon him or herself to start eating healthier immediately after being exposed to such information. As the patient or user he leaves the office his or her record is updated, processed and the content of diabetes (care plan or whatever) videos, audio, written, suggestions, blogs to join, insulin information, healthier living, health clubs that offer assistance with such problems, etc., are all populated into the patient profile so he or she can then start the learning process, take quizzes, receive credit for watching the video, etc., which may be a condition precedent to receiving access to another physician visit.

The term “diabetes” may be identified and corresponding content records may be accessed from a third party information source server to include in the user's health care management record. The information may be presented as web links, quizzes, videos, electronic brochures, audio content, etc. The content may be required to be observed by the user in order to educate the user about the present condition and certain measures to alleviate the side effects of the present condition.

The virtual nurse application may be responsible for tracking user compliance with the education materials and any other actions which are required as part of the user's health and care plan. The virtual nurse may be presented as a healthcare and wellness avatar that communicates user information to other parties involved in the user's healthcare. The application may be associated with an enterprise database that may reside on premises or in the cloud. The user's health care record or wellness record may be a virtual nurse specified type of record or may be linked to a patient electronic medical record (EMR) or electronic healthcare record (HER) stored in a remote database.

According to example embodiments, the procedure of identifying at least one new term or event included in the modification or status record may provide creating a response to the new term or activity in the patient's healthcare management record stored in the database. The response may be creating a new appointment, requiring a patient take a quiz after watching a video, creating an emergency contact list to assist the patient in the event of an emergency, having an emergency contact button or link that quickly puts the user in touch with emergency medical services or a live agent ready to assist the patient.

FIG. 3C illustrates an example prescription maintenance setup and maintenance application according to example embodiments. In this example, the document correlation 380 illustrates how the user's conditions are paired with certain subscriptions. This correlation may trigger a prescription reminder be sent to the user to ensure they have filled their prescriptions and can be scored or identified as having done so for the system's patient records 332. If the user fails to fill a prescription, it may cause negative feedback that may reduce the patient's overall health care score that triggers the need to contact the doctor, automatically generate an email to contact the doctor or increase a readmission likelihood or trigger to visit the doctor based on a scoring algorithm used to manage the user's health care.

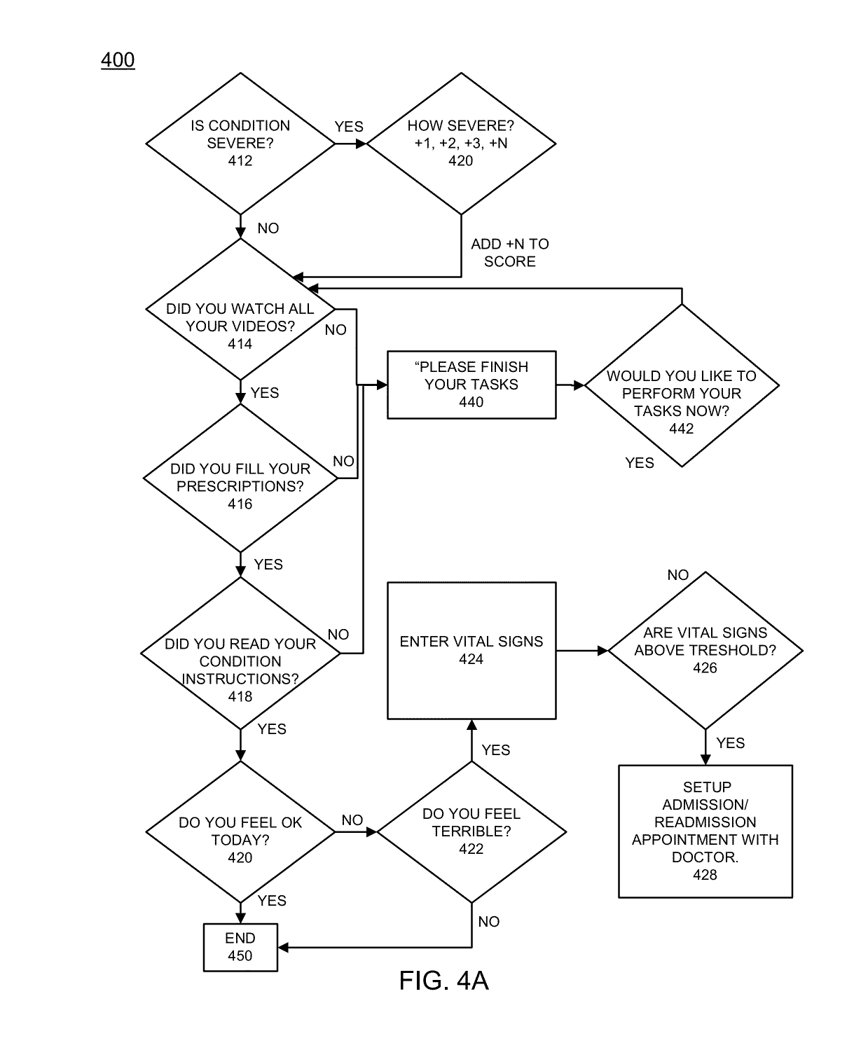

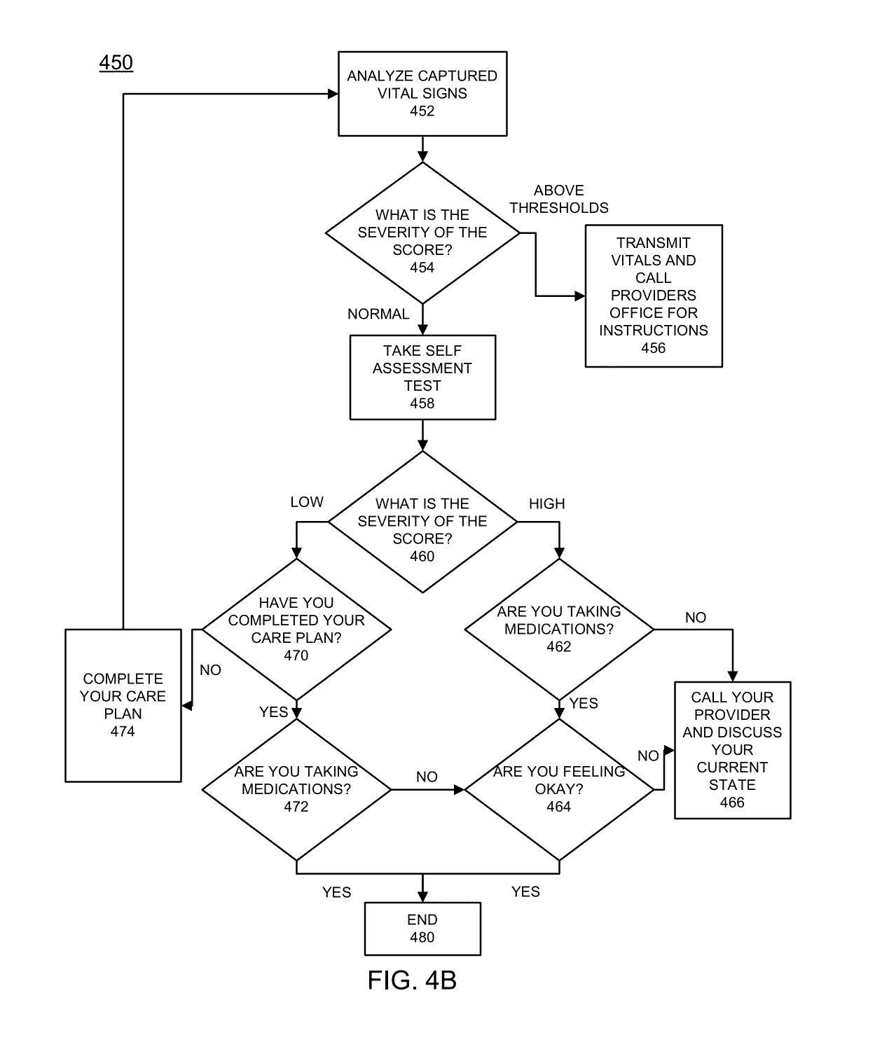

FIG. 4A illustrates a flow diagram of patient health care management operations according to example embodiments. In FIG. 4, the flow chart 400 provides a detailed analysis of whether the patient has a severe vs. a non-severe condition. Once a determination is made, the patient may have a basic condition score adjusted 420 to consider the possibility that their condition is serious or sever 412. For example, depending on the severity of the condition, the score may be fundamentally higher which may trigger an ER visit, a physician appointment, etc., sooner if the patient's health is determined to be degrading or is not improving at the rate anticipated. The patient may receive credit or an addition to his or her health score if they comply with content observing activities 414, prescription compliance procedures 416, daily notes about their condition(s) 418, relative well-being questions 420, etc.

The patient may have a pulse, blood sugar, blood pressure, breath meter, heart EKG, etc., sensor that is in a direct connection or in communication via a wireless medium (BLUETOOTH®) with the computing device. The patient may enter their vital signs 424 with the application and the information may be stored in a database and scored based on the expected results. For example, if the user answers ‘YES’ to taking their blood pressure medicine and their blood pressure is higher than it was at the in-person appointment prior to the prescription being filled and administered, it may be useful for the patient to have his or her medication dosage increased. The score may dictate that a review is necessary. As a result, the physician may receive updates about their patient's scores that are improving, not improving, etc. If a patient is not improving the system may suggest a course of action. For example, the system may report to the physician “the patient's blood pressure is still high 140/90, consider increasing the initial dose of the blood pressure medication”, and the physician may have an automated response system that changes the dosage automatically and/or which may require physician approval, but which course of action is initiated automatically. In another example, if the patient reportedly is feeling terrible and is continuing to report negative progress, then the user's score may continue to decrease. If the patient's health score falls below a predetermined threshold, a doctor's appointment may be setup automatically to have the patient return to the doctor for a follow-up visit 428.

Example embodiments may provide identifying a prescription drug and dosage currently administered to a user and then accessing the patient's records to change the dosage if necessary based on many different inputs identifying pain, high BP, based on other input data provided by the user, etc. Some medications can have their dosage changed to change a patient's current health condition, such as Insulin, BP medication, pain medication, cholesterol medication, thyroid medication, nausea medication, etc.

One example method may include identifying at least one medical prescription currently associated with a user's health care record including but not limited to a patient's electronic medical record (EMR), electronic health record (HER), interactive health application record (IHAR), a wellness record, HMO records, and pharmacy records), identifying an initial dosage requirement of medical prescription being administered to the user and generating an inquiry in the user's health care record and receiving a response to the inquiry, such as a physician confirmation to an automated recommendation. Then the application may determine whether to create a dosage modification based on the response or responses received.

The inquiry to the user or the user's caregiver may inquire as to the prescription dosage currently taken. The inquiry may also pertain to the prescription schedule adhered to, including but not limited to time of day taken, frequency per day, route of administration, and connectedness to meals or beverages. Other inquiries may provide user drug allergies and/or a listing of all prescription medication currently being taken. Such information could be used for reasons including but not limited to determining drug interactions, notifying patient of chronic drug rebates, discounts or other incentives. The response to a user inquiry may be an automated recommendation to alter the prescription in a manner including but not limited to dosage, frequency, route, and concomitant medication. The response to the user inquiry may be a recommendation to alter the prescription in a manner including but not limited to dosage, frequency, route, and concomitant medication that is submitted to the appropriate user's health care professional for approval.

The user's prescription adherence information is correlated with physical user information. This correlation information may be used for purposes including but not limited to determining possible adverse events and side effects. The user's prescription adherence information is correlated with physical user information (e.g., known patient data measurements, blood work numbers, recent vital signs and other data) and this data is sent to the user's health care professionals and other authorized parties. The medical prescription currently associated with a user's health care record may be identified from the EMR, EHR, interactive health application record (IHAR), wellness record, HMO records, and/or pharmacy records and may be identified as having an initial dosage requirement prior to determining whether to create a dosage modification including prescription discontinuation or substitution based on the response or responses discussed above.

According to another example embodiment, FIG. 4B illustrates an alternative approach to tracking a user's health score and modifying it accordingly to consider readmission or alternative health care treatments. Referring to FIG. 4B, the flow diagram 450 provides that a user may offer certain vital signs 452, on a multiple time per daily basis, daily, weekly, etc. and the information may be transmitted to the users' tablet computing device and recorded to the user's record over the Internet. The vital signs may be analyzed and scored depending on the patient's targets. For example, the doctor may establish a baseline or threshold initial blood pressure basis as one example of a vital sign. In this example, the basis for someone with high blood pressure who is just beginning a medication regiment would begin with a baseline or threshold of 150/90. Therefore, it the blood pressure remains at that level, the doctor will not initially take any additional actions pending prescription results at least for a certain period of time (e.g., two weeks). However, if the level increases by a default level 10%, 15%, 20% or a doctor specified level and maintains that level for a week or more, the medication should likely be increased and vice versa if the pressure drops drastically. In another example, for the chronic condition CHF, a patient is often weighed daily to ensure the patient remains euvelumic, rapid subtle weight changes could indicate that the patient's medications need further adjustments. Over the course of a week, any significant (i.e., 3 pounds or more) weight changes should be reported to the physician for medication adjustment or possible readmission.

The resulting condition identified from the vital sign logging efforts could be correlated with the patient's score and if the determination 454 is that the score is above a threshold, then the vital sign information may be transmitted to the call provider for instructions 456, however, if the determination is considered normal based on the threshold values compared to the user's score then the user may take the self-assessment test 458 to determine if they are sick or understand the condition they are experiencing. The score may be again analyzed 460 to determine if the user is maintaining their care plan 470 by watching their videos, taking their prescriptions, etc., and if not then the care plan may be initiated again to ensure compliance on the user's computing device 474. If the user is taking his or her medications 472 then the process will end 480 pending no further disruptions at that time interval. If not, the user may be prompted to indicate how he or she is feeling 464 on a scale 1-5, 1-10, etc., if the patient is feeling poorly, the provider may be called to discuss the current state of the user's health. The user may be asked about his or medications 462 if the user's score is high and may result in a similar action being taken.

The new term or event may include a lack of compliance by the patient to the physician or health care professional's prescribed care plan, such as failing to take a quiz or complete a training session within a specified period of time, failing to confirm medication was administered properly, failing to respond to an inquiry, failing to input pain measurements, failing to offer vital sign measurements via the computing device, etc.

Other events that cause the trigger to initiate and take a corresponding action may include a pain level measurement that includes a visual analog score confirmed by an automated procedure or a manual live agent as exceeding a particular threshold. This threshold may be created by a treating physician or other health care professionals and may be a numerical score measured over a predefined period of time. Other measurement and potential trigger actions may be based on a localization of pain communicated by the user and linked to a two or three-dimensional diagram. The trigger term may be linked to a nausea threshold determined by the treating physician or health care professionals and confirmed by the patient in a question and answer session with the virtual nurse application. The trigger term may be a fatigue and or tiredness threshold determined by the treating physician or health care professionals and confirmed by the patient in a question and answer session with the virtual nurse application. The trigger term may be an appetite threshold determined by the treating physician or health care professionals and confirmed by the patient in a question and answer session with the virtual nurse application. The new term is a drowsiness threshold determined by the treating physician or health care professionals and confirmed by the patient in a question and answer session with the virtual nurse application. The new term may be a general well-being threshold, such as the Karnofsky performance index (KPI) as determined by the treating physician or health care professionals and confirmed by the patient in a question and answer session with the virtual nurse application. The new term may be a shortness of breath threshold including but not limited to FEV1 score as determined by the treating physician or health care professionals and confirmed by the patient in a question and answer session with the virtual nurse application. The new term may be an anxiety threshold determined by the treating physician or health care professionals and confirmed by the patient in a question and answer session with the virtual nurse application. The new term may be a depression threshold determined by the treating physician or health care professionals and confirmed by the patient in a question and answer session with the virtual nurse application. The new term may be a xerostomia threshold as determined by the treating physician or health care professionals and confirmed by the patient in a question and answer session with the virtual nurse application. The new term may be a blood pressure threshold determined by the treating physician or health care professionals and confirmed by the patient in a question and answer session with the virtual nurse application. The new term may be a constipation score threshold determined by the treating physician or health care professionals. The new term may be a glucose level threshold determined by the treating physician or health care professionals and confirmed by the patient in a question and answer session with the virtual nurse application. The new term may be a heart rate threshold determined by the treating physician or health care professionals and confirmed by the patient in a question and answer session with the virtual nurse application. The new term may be a body temperature (fever) threshold determined by the treating physician or health care professionals and confirmed by the patient in a question and answer session with the virtual nurse application. The new term or event may be a reading from a user-attached GPS-enabled device exceeding a pre-determined distance from the users domicile. The new term or event may be related to a wound healing response falling outside of a threshold determined by the treating physician or health care professionals and confirmed by the patient in a question and answer session with the virtual nurse application. The new term may be a partial oxygen (pO2) threshold determined by the treating physician or health care professionals and confirmed by the patient in a question and answer session with the virtual nurse application. The new term may be a body mass index (BMI) threshold determined by the treating physician or health care professionals and confirmed by the patient in a question and answer session with the virtual nurse application. The new term or event may include the consumption of two or more prescriptions with detrimental interactions including but not limited to drug-drug interaction and patient allergies) by the patient and confirmed by the patient in a question and answer session with the virtual nurse application. The new term may be a hearing threshold determined by the treating physician or health care professionals and confirmed by the patient in a question and answer session with the virtual nurse application. The new term or event by the patient is determined by any one of various input mechanisms, answer selection, and/or certain external devices connected directly or via BLUETOOTH or other wireless protocols to the virtual nurse application enabled device, including but not limited to: prescription containers not accessed on a schedule consistent with the patient's prescription plan, a patient weight scale, an electro cardiogram (EKG), patient motion sensors either attached or unattached to the patient for purposes including but not limited to the prevention of lesions due to low mobility, lack of or irregular respiration including but not limited to sleep apnea or other respiratory, cardiovascular, or a pulmonary ailment. The record modification may be based on communication including but not limited to an alert via email, telephone, video conference, VOIP communication, facsimile, or other communication channels with the patient's physician or other members of the patient's care team.

Other examples may provide the new term or event being a depression threshold determined by the treating physician or health care professionals or other indicator determined by healthcare professional or other qualified personnel that triggers a suitable response to a suspected suicide including but not limited to a 911 call, a call to the patients physician, a call to the patients designated emergency contact, a call to the patients psychologist, or other appropriate personnel. The new term or event may also be the patient physically triggering a button, soft key, or other activation feature on a virtual nurse application enabled device including but not limited to activating a “panic button” due to suicidal thoughts due to excessive depression, etc. The new term or event may also be the patient physically triggering a button, soft key, or other activation feature on the virtual nurse application enabled device including but not limited to activating a “panic button” due to a fall, or other disabling physical event. The new term or event may also be a predetermined sound, sound threshold, motion, motion threshold, lack of motion, or other visually encoded information including but not limited to sounds, motions, or images that can be sensed and transmitted by devices such as tablets, smartphones, and appropriately equipped personal computers and determined by the patient, infant or subject's caregiver or parents including but not limited to a visual analog score threshold determined by the treating physician or health care professionals. The new term or event may instead be determined by utilizing data from the patient's health records including but not limited to EHR, EMR, lab tests, physician's office data, etc., that can be accessed by the virtual nurse application software by logging into the patient's existing health record database with the patient's username, password, and other required logon information being provided to the virtual nurse or health record application. Also, the new term or event data that is communicated to a healthcare professional by the health management software may include various known providers, such as EPIC SYSTEMS, PRACTICE FUSION, NEXTGEN healthcare, ALLSCRIPTS, AETHNA healthcare, ECLINICAL WORKS, etc.

According to one example embodiment, a user may have his or her condition monitored via the assistance of the mobile computing device operating the virtual nurse/interactive health record application. For example, the user may provide user input selections from a number of inquiries generated to receive user input (e.g., questions, vital sign tracking, task completion, etc.). The application may receive the various inputs and generate one or more numerical scores corresponding to each user input selection, some may be based on specific user input including pain measurements, improvement measurements, divergence measurements (e.g., feeling like a 2 out of 10 compared to yesterday's 8 out of 10). The application may incorporate at least one numerical score to determine a user's overall health score which may be a function of 5, 10, 15 or 20 or more independent scoring mechanisms, which are summed and divided by the total number of scoring parameters, or which are based on a larger weighted average of the more important scores combined with less important and less weighted scores to arrive at a more accurate overall health score. The process may also include determining whether the user's overall health score is outside of predetermined limits or thresholds, and thus a response may be invoked, such as including but not limited to creating a notification alert, invoking a health care appointment, and generating a phone call with a pre-recorded message if the user's overall health score is outside of those predetermined limits (e.g., above a 7.5 out of 10).

The user input to the user's health care record or wellness record managed by the computing device application may include but is not limited to a record in the interactive health record database, an EMR database and/or an EHR database stored in a database accessed via a tablet, smartphone, personal computer, or other suitable device. The user input may be communicated to the user's treating physician or other health care professionals identified from the one or more patient records. The user input to the user's health care record or wellness record may also include a record in the interactive health care database, EMR database, EHR database or another database accessed via the tablet, smartphone, personal computer, or other suitable device. The application may store data and can be hosted and accessible via a third party cloud facility or servers physically located at a suitable facility.

The user input may be communicated to the user's treating physician and/or other health care professionals who are part of the user's care network including, nurses, home aides, family, etc. The numerical score(s) corresponding to at least one of the user's input selection may be assigned a threshold by the user's physician or other health care professionals. By way of example, the Edmonton symptom assessment system (ESAS-R) may be used to assess at least ten parameters (e.g., pain, tiredness, drowsiness, nausea, lack of appetite, shortness of breath, depression, anxiety, well-being and other symptoms) and based on that score from 0-10. A medical professional may determine that composite scores using the nine primary ESAS-R parameters from 0-36 constitute “good” scores that can be coded green, scores from 37-71 constitute a “o.k.” scores that can be coded yellow, and scores from 72-90 constitute “poor” scores that can be coded red. This color coded algorithm could provide the basis for taking action. For example, a green score could result in no action. The yellow score could result in a non-urgent note being generated and transmitted to the physician of record and the patient's next of kin being contacted. The red score could result in immediate emergency services or a same day visit being required depending on the configuration setup by the overseer (i.e., physician).

In another example, at least one numerical score corresponding to at least one of the user's input selections is assigned a threshold by the user's care provider or a family member. Also, receiving user input selections or a lack of selections including but not limited to actions, such as a user not performing healthcare professional specified care plan activities, nutritional regiment compliance, prescription drug compliance, physical therapy and exercise. The user input is communicated to the user's treating physician or health care professionals. The application may also receive a user's mobile device input for safety and healthcare compliance plan purposes including but not limited to time stamped global positioning system (GPS) data indicating lack of patient medical appointment compliance, wandering individuals due to senility, amnesia, dementia, Alzheimer's, or other medically disabling conditions. The user's device data may be communicated to the user's treating physician, health care professionals, family members and or healthcare providers.

According to other examples, the action triggers may be based on a combination of patient compliance and more accurate patient health data, such as updated patient vital information, which can be monitored via computing device peripherals which are linked to the computing device, such as sensors or BLUETOOTH compatible devices that measure patient blood pressure (BP), heart rate (HR), blood sugar (BS), pain, time since the last appointment, etc. These vitals can provide the basis for a threshold decision to have the patient seek immediate medical attention or have an elevated situation be demoted or reduced to a less elevated situation. For example, if a patient is reporting pain and is not complying with a particular set of instructions, the user status may be elevated and require additional input or require attention from a patient care person or service. In such a case, the patient vitals may be cross-referenced for a second opinion or as a backup measure to confirm the patient's status. In the event that a patient is identified as being in an elevated situation, the patient vitals being low HR/BP may reduce the elevated condition back to stable. However, if the elevate status is matched with high vitals HR/BP then the action may be taken immediately since the patient input and the vital information dictates the patient is experiencing a difficult situation and may be in pain.

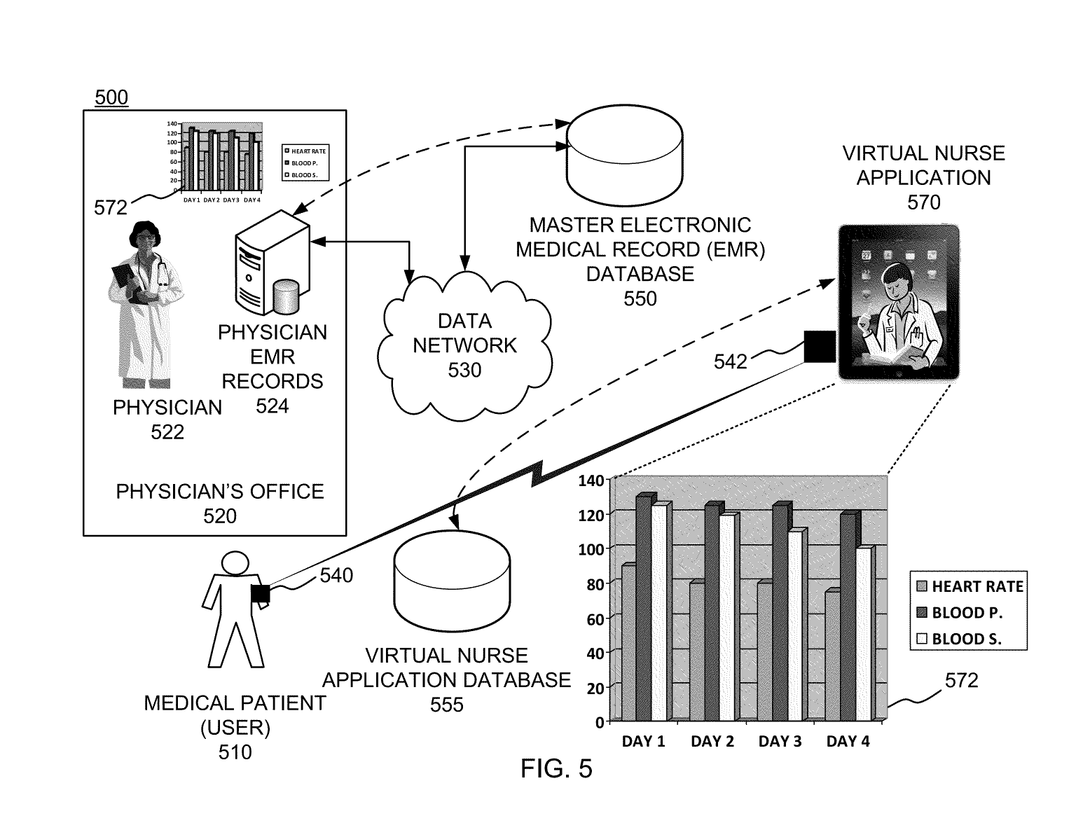

FIG. 5 illustrates an example patient scoring procedure and subsequent patient update procedure according to example embodiments. Referring to FIG. 5, the configuration 500 provides a medical patient 510 who has been utilizing the virtual nurse and home health interface 570 over a period of time. In this example, the user may setup a vitals monitor 540 that communicates with a wireless or wired sensor 542. The information may be based on a user's heart rate/pulse, blood pressure, breath patterns, EKG (heart), blood sugar, etc. As the user is being monitored by the application, a chart 572 may be created to identify the user's vitals and the progress over a day, a week, a month, etc. The physician 522 and the online EMR records 550 and/or the virtual nurse application database 555, or the physician records 524 may be updated automatically to permit the physician to have a snapshot or a preemptive knowledge of the patient's condition. If the patient's health is improving, then appointments may be avoided or cancelled, and the health degrades, the appointments may be setup automatically and confirmed by the physician.

The user may input their vitals once a day as part of a health care management regiment setup by the health care plan service. A user with a severe health condition may have various vital signs that need to be monitored via a home based sensor reading configuration that is integrated with the plug-in port of the tablet computing device. As conditions improve, the user's health score may decrease, as conditions worsen the score may increase and may cross a predetermined threshold invoking an office visit be setup automatically with a physician.

In another example embodiment, the user's frequent health data including but not limited to vital signs, pain selections, symptom selection, etc. may be organized in a time elapsed summary format including one day, two days, one week, one month as a medical summary and which may be offered to the user's caregiver, physician, nurse, etc. to gauge the progress or lack thereof being experienced by the user over the predefined period of time.

Such patient information may be used as the basis for subsequent appointments, medication modification events, integrating the user health diagnostic data with a user's existing health care record, etc. For example, a health risk factor may be identified based on the user health diagnostic data automatically by the interactive health application and used to invoke a response to including scheduling a patient care appointment, adding or modifying the user's exercise and nutritional regiment, modifying the user's care plan, modifying the user's medication and/or modifying the user's care team persons.

The identified health risk factor pertains to anyone having various user parameters including but not limited to patient temperature, blood pressure, pO2, glucose level, heart rate, height, weight, anxiety, dehydration, well-being, pulse rate, body mass index, cutaneous or other patient images, wound healing, shortness of breath, depression, anxiety, nausea, appetite, otoscope images, retinal images, skin conductivity and xerostomia. The identified health risk factor pertaining to anyone of the various user parameters may be used to create context sensitive advertising for the user delivered via the interactive health application platform, online communities, social networks, facsimile, email, and SMS.

Another example may include receiving the at least one recurring user health diagnostic information via a hardware sensor input from sensors attached to a mobile device operating the interactive health application to provide feedback to inquiries, and which may have a BLUETOOTH pairing data interface to connect with the patient worn sensors. The user device may receive an inquiry, such as “How are you?” and “Did you fall today?” The inquiry may be generated based on the accelerometer data from the user's device exceeding a pre-determined threshold and being reported or processed by the application. For example, accelerometer data generated from an accelerometer in the user device may indicate at least a 90 degree change in direction for a particular period of time. This may invoke a question and response session to confirm the user is not on the floor or in pain. Another example may include inquiries, such as “Did you take your medication three times today?”, which may be invoked by a lack of sensory data response by a sensor cap medication that indicates when the top is moved off the container and a corresponding signal is transferred to the application operating on the mobile device via a BLUETOOTH wireless signal transmitter and receiver pair. The pill bottle sensor may trigger a movement of taking the top off the container or not taking the top off the container multiple times per day. This sensory indication may be based on a periodic schedule of multiple times a day (e.g., three times a day) on a day in question could trigger an automated response to the appropriate personnel or a patient condition logging journal, etc.

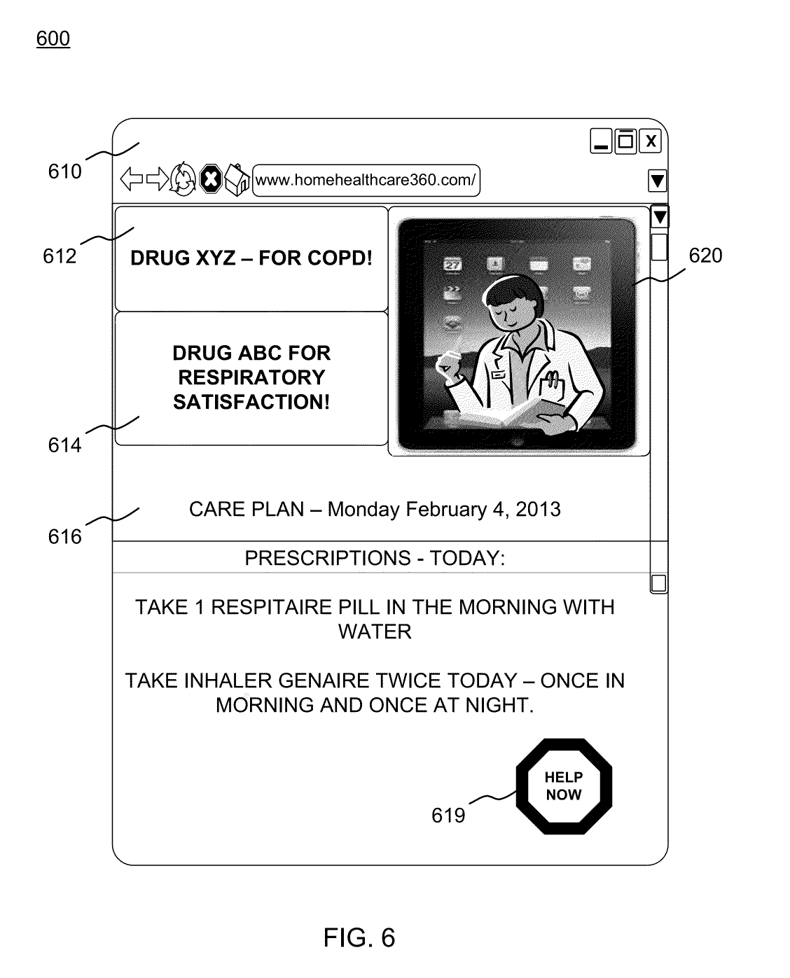

FIG. 6 illustrates an example patient vital sign update and recording procedure according to example embodiments. In FIG. 6, the user interface 600 may be on the user's tablet, smartphone, laptop, etc., and may be browser-based 610 or independent-application based depending on the computing platform and preferences. In this example, the user may be exposed to various information sources all tied to a central application interface 600. For example, the user may be able to communicate with the virtual nurse 620 at any time, however, the banner 612 may generate a drug advertisement for a drug tied to the user's current conditions, age, etc., from the user's chart and may provide a revenue stream for the application manufacturer to offer targeted advertising to certain users for potential drug requests and inquiry. The advertisement may be tied to an automated sample generation and delivery process, an automated patient-doctor inquiry process or other integrated process that links the user's exposure to the new drug to their current care plan. Other advertisements may be in other banners 614 and may be generated from an advertisement database based on the retrieval of a particular users' chronic condition information and the comparison to the drug advertisement data file and its corresponding metatags stored in the database. The current care plan may be displayed on the user display 616 with a date, a goal, and a live counter to identify a number of notifications or tasks remaining to be updated on the current care plan.

Within the operating homepage or dashboard of the interactive health application (see FIG. 6), the patient may have a panic button on the home page (HELP NOW!) 619, this permits the user to connect directly to emergency services to obtain urgent help for a variety of purposes. The action taken by selecting the button 619 may be configured to perform any of a variety of actions, call 911, call a specified number, contact a patient care facility, etc., it can be turned off and may be automatically turned on and off remotely from a remote source or as a patient condition changes (e.g., cancer diagnosis) to enact the privilege of an immediate assistance button. In operation, the tablet computing device operating the interactive health application may call the care provider or have their home phone make a call to connect them to the on-call care provider.

When a new patient is added to the application system, care providers may be assigned from the current list to be assigned to that patient. When a patient is assigned to a care provider, that care provider's information is automatically added to the patient's email contact list and the patient information may be automatically added to the provider's email contact list. The email, tasks and calendar tiles may be created for the user account to indicate how many new emails are available, tasks that are overdue and meetings scheduled for today. When outstanding items are required to be addressed, such as videos to watch, emails to read, etc., a notification (reminder) is generated and circulated to all interested parties. Examples of medication reminders may be placed in new schedule lists that make it easy for the user based on automated reminders.

Also, when a new patient is added to the application system, a pre-admission index process can be used to accurately predict early death or unplanned readmissions after hospital discharges by using certain variables that could influence these outcomes. The probability of the readmission index and the patient's initial pre-admission index together can provide an accurate estimate of the patient's current risk. Additionally, if the patient content titles requiring watching, viewing, listening, etc., are numerous and overwhelming large, the application can prioritize the order that the patient is required to view their care plan so as to maintain a minimum status quo. The physician's office or other interested party may desire to have the patient to view the videos first before the electronic literature guides. The higher priority items may be mandatory while the less important materials may have little or no weight with a user's compliance score for managing his or her responsibilities associated with his or her chronic health problems.

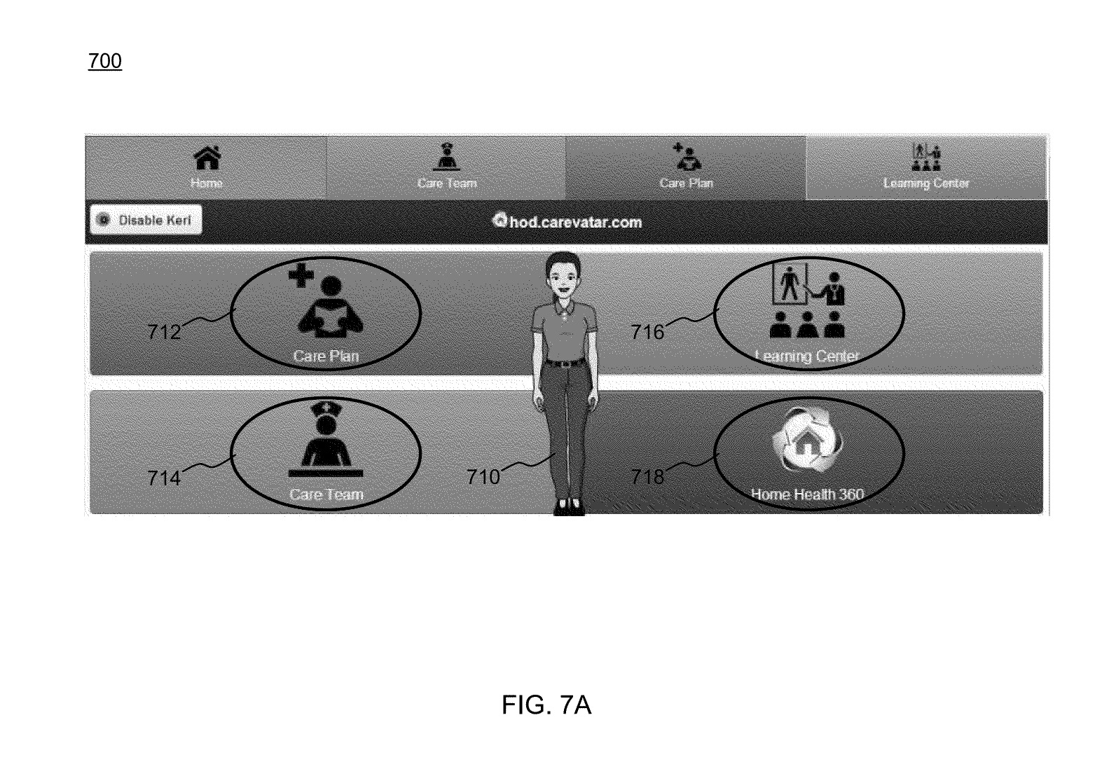

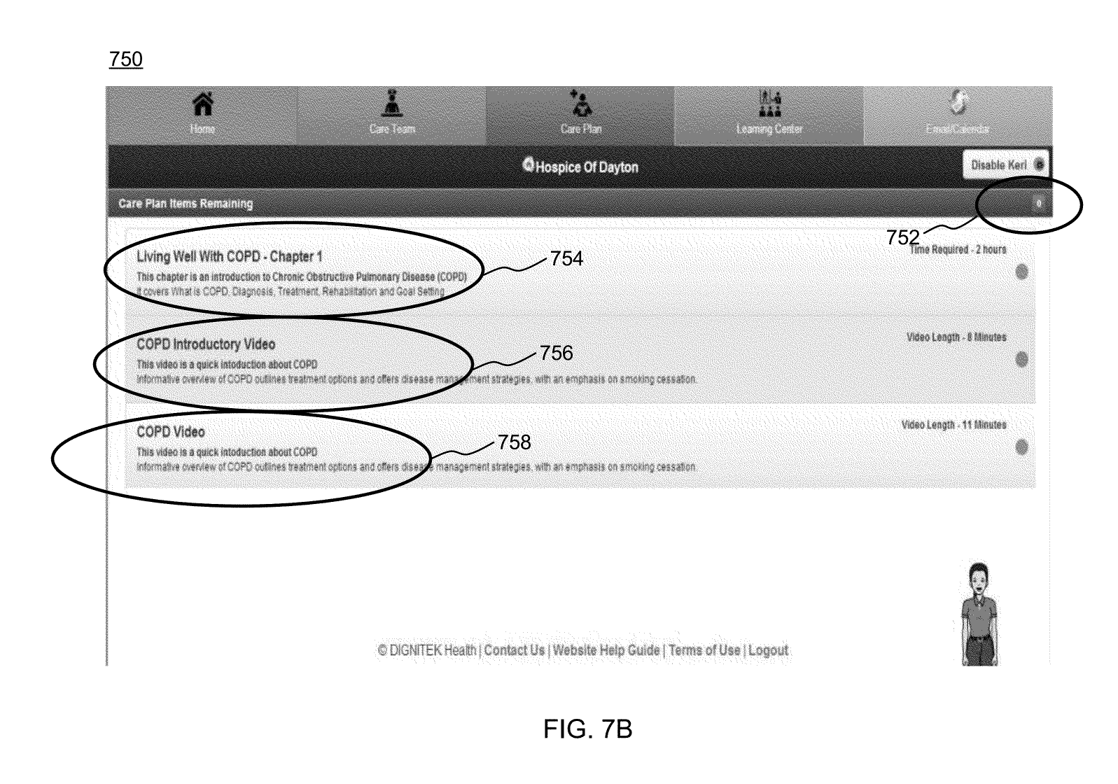

According to another example embodiment, a user may have recently experienced an update in his or her patient records including but not limited to a new diagnosis, a new medication, or any other term that is new or is correlated with a condition treatable by a prescription drug. Those terms can be extracted and parsed and compared with a list of terms in a separate data file which has a link to a drug with an advertisement or other form of communication. Once the term is identified in the user's health care record it can be compared to other associated terms or information and the user's age range or other data, such as chronic conditions present in the user's health care record can be retrieved and linked to an advertisement for a medical treatment based on the user's age and chronic conditions to generate a message in the user's health care record with a link to the advertisement. For example, an email with a link to “click here for information on a new drug that may treat your [enter {parsed condition}]”. Other advertisements may be automatically inserted into a banner or portion of the user's interactive application dashboard (see FIGS. 6 and 7A). Other advertisement communication may include a display on a website, a short message service (SMS) message a phone call, an email, and/or an advertisement within the patients care plan information and/or videos etc.

Examples of new terms may include predefined values for one or more of a number of physical patient characteristics including but not limited to pain, nausea, anxiety, dehydration, fatigue, blood pressure, heart rate, body temperature, pO2 (oxygen saturation), blood alcohol content (BAC), depression, xerostomia, constipation, wound healing, alopecia, appetite, exhaustion, tiredness, drowsiness, shortness of breath, forced expiratory volume (FEV1), well-being, and glucose level. Also, the advertisement may be customized based on the one or more new terms and transmitted for display in the user application dashboard, video, email, SMS (short message service), fax, etc. Customization may be based on identifying one or more characteristics associated with the new term inquiry which includes identifying font characteristics associated with the inquiry, and modifying a font of the advertisement based on the font characteristics associated with the inquiry or other stylistic features of the inquiry. For example, the inquiry may include a dominant font used within the inquiry. Also, receiving new terms may provide identifying an advertisement placement area in the user dashboard and identifying one or more characteristics of the new term surrounding the advertisement placement area in the user dashboard. The characteristics of the advertisement may then be modified based on the characteristics associated with the content of the user dashboard which includes modifying the characteristics of the advertisement to integrate the advertisement with the dashboard content. Additionally, the new terms may be identified with an advertisement to be displayed in a social network associated with the new term and linked to the user's account or a healthcare social network associated with the new term.

In another example, the user's input or comments posted in an online community may be identified and compared to a list of keywords or a predefined list of associated terms. Then, an advertisement may be retrieved for a relevant product or service and made accessible to the user via the online or social networking account. This access may be provided in a variety of ways including but not limited to a display on the application dashboard, an enterprise software system, a social network, an online community, a job board, a medical supplies provider, an online pharmacy, a link to the advertisement, a display on a website, a SMS message, a phone call, an email, advertisement within the patients care plan and/or videos, etc.

FIG. 7A illustrates an example GUI of a virtual nurse avatar service of a health care service application, according to example embodiments. Referring to FIG. 7A, the user interface 700 may represent a default view of the virtual nurse and the various navigation options to attend to a user's care plan, game plan, etc. In this interface example, the user may be accessing the virtual nurse application via his or her computing device at home or outside the doctor's office. The user may identify the virtual nurse icon 710 to ask questions or to hear navigation menu options. The user may select any of the four main categories of information and assistance for the user's health care concerns. For example, the user may access care plan 712 as a simple way to view the items that are automatically setup for the user to read, understand and to provide feedback to keep the user's health score updated. Learning center 716 is a simple option to view learning materials and access information which may be relevant to the user give his or her current health status. The home health option 718 may provide background and high-level information regarding the user's account and current status. The care team 714 is a simple way to view the doctor's profiles, navigation menus and other information pertaining to the user's team of doctors, nurses or other assistants and their locations.

FIG. 7B illustrates examples 754-758 of the various care plan items under the care plan interface 750 that need to be addressed by the user, such as videos to watch 756 and 758, and electronic book chapters to view or hear 754. The user may select and watch any of the videos or read or listen to the books and/or brochures to become updated with user information pertaining to the user's conditions. The counter 752 may provide a number of items that have yet to be selected and watched. The user may leave and return where they left-off to complete the cycle of identifying items of interest and to receive the credit for watching a particular video or reading a particular chapter. The completed items may contribute to the user's health score to ensure compliance with the health care plan and to identify when visiting the doctor may be justified.

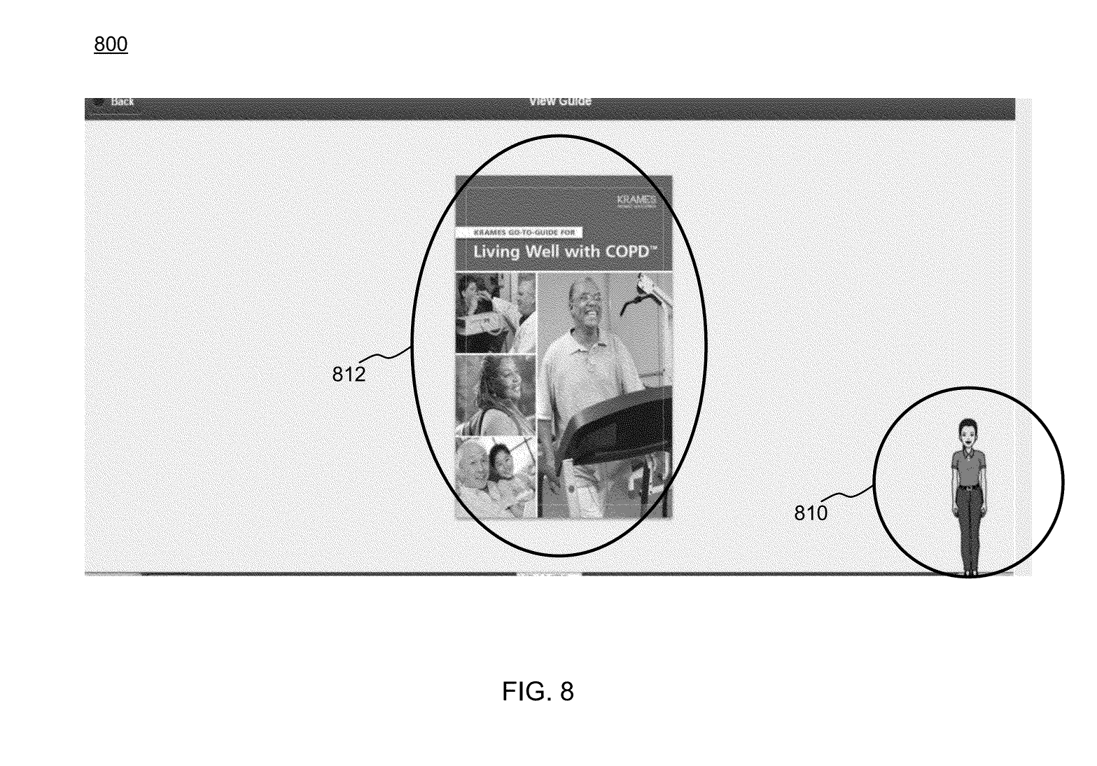

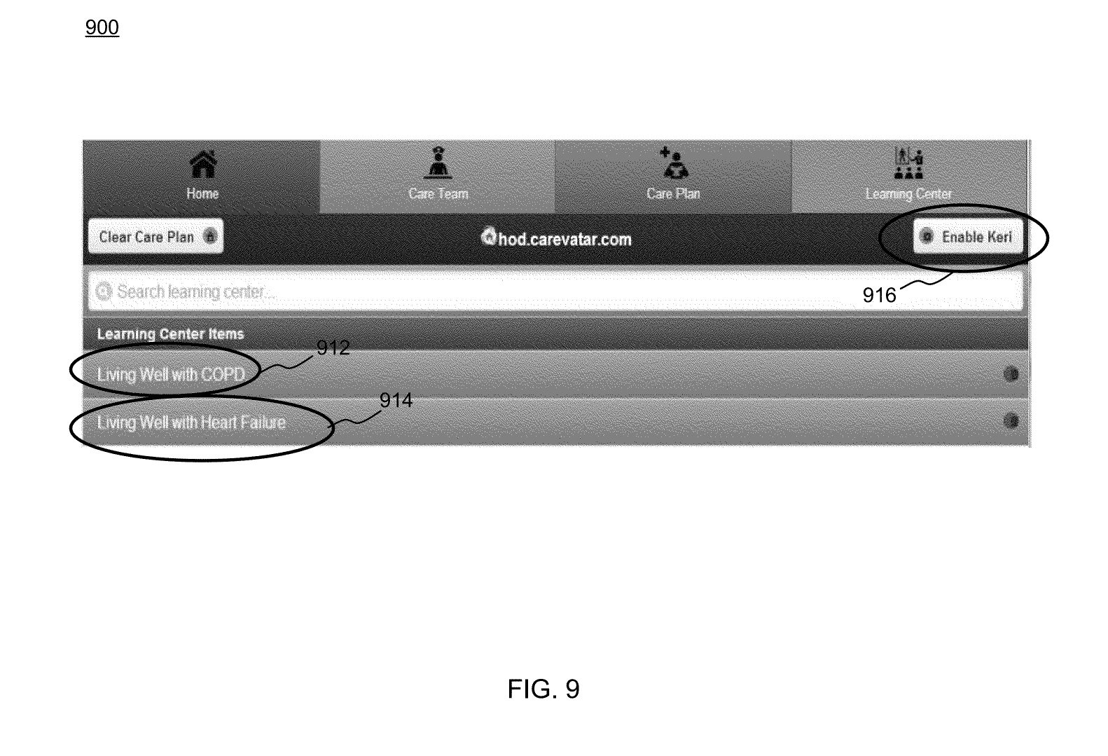

FIG. 8 illustrates an example content sharing function of a health care service application, according to example embodiments. Referring to FIG. 8, the user interface 800 includes an electronic guide 812 for a user's current health condition. The virtual nurse is present 810 to ensure the user is able to navigate the guide and complete his or her information session to receive the corresponding credit. FIG. 9 illustrates another example interface 900 of a menu option that provides different tabs for each user health condition 912 and 914 and to enable the care plan virtual nurse if necessary.

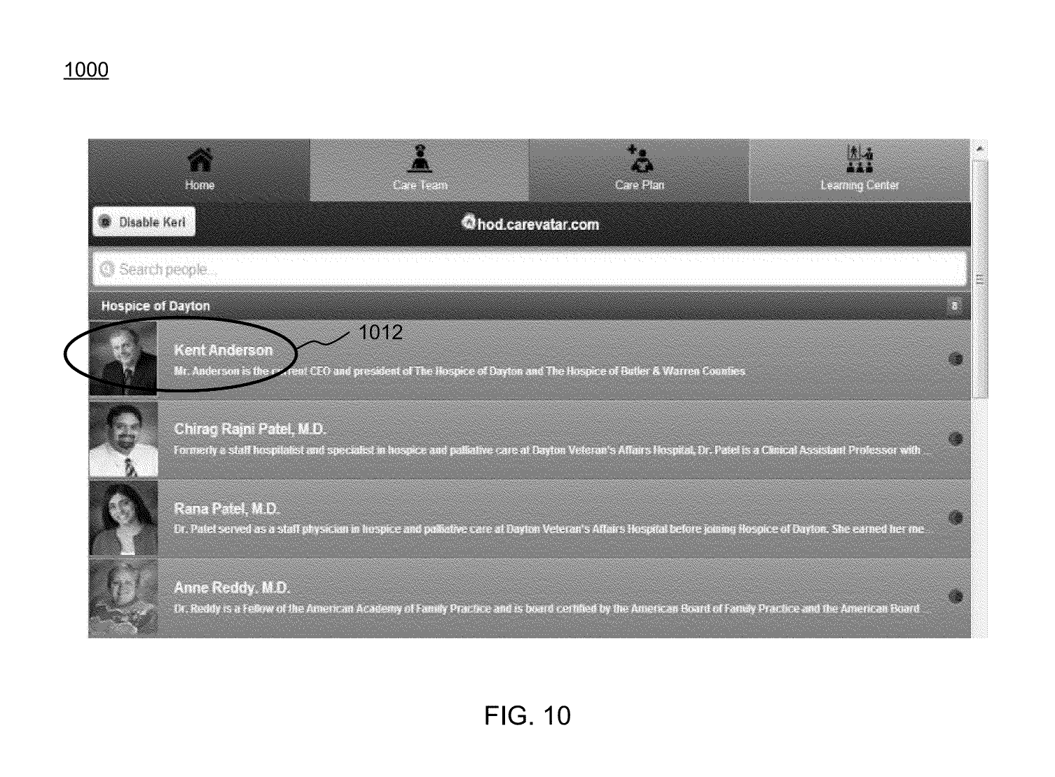

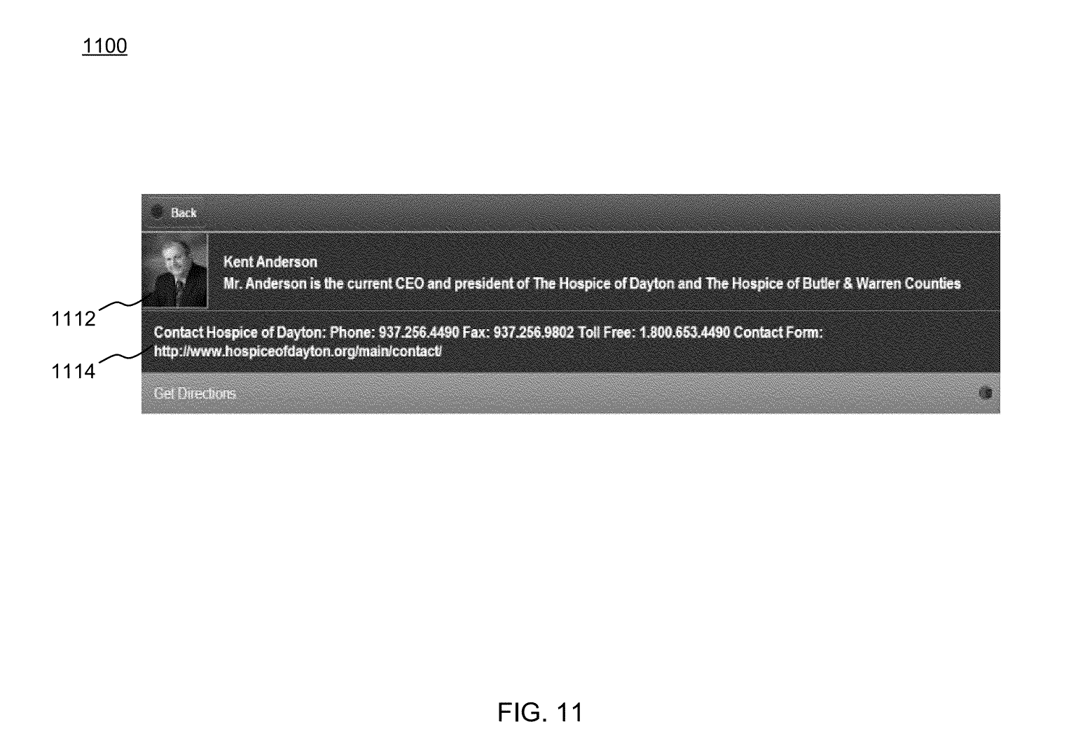

FIG. 10 illustrates an example physician selection interface of a health care service application, according to example embodiments. Referring to FIG. 10, the doctors that are in charge of the facility 1012 visited by the patient and/or the patient's current doctors may be listed in a readily accessible format for the user to identify the doctor's credentials and select the doctor for easy directions to his or her office. For example, in FIG. 11 an example of a detailed physician selection interface of the health care service application is illustrated as providing the user with access to the doctor's detailed information 1112 for easy reference purposes and contact information 1114.

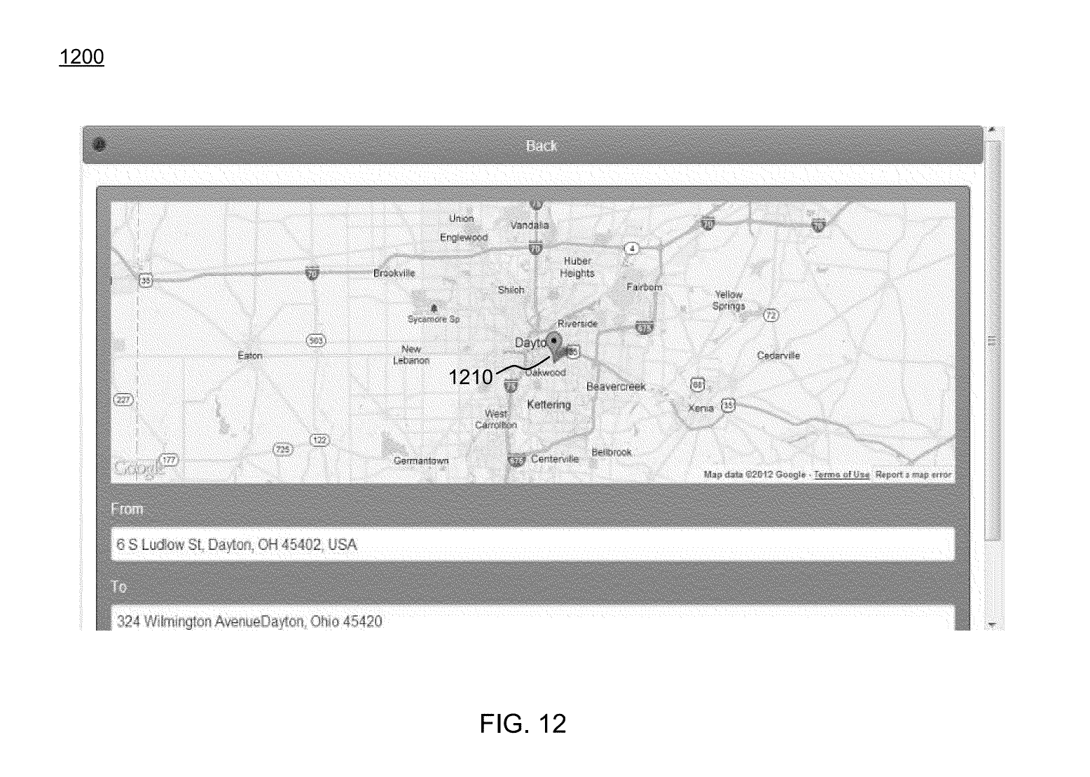

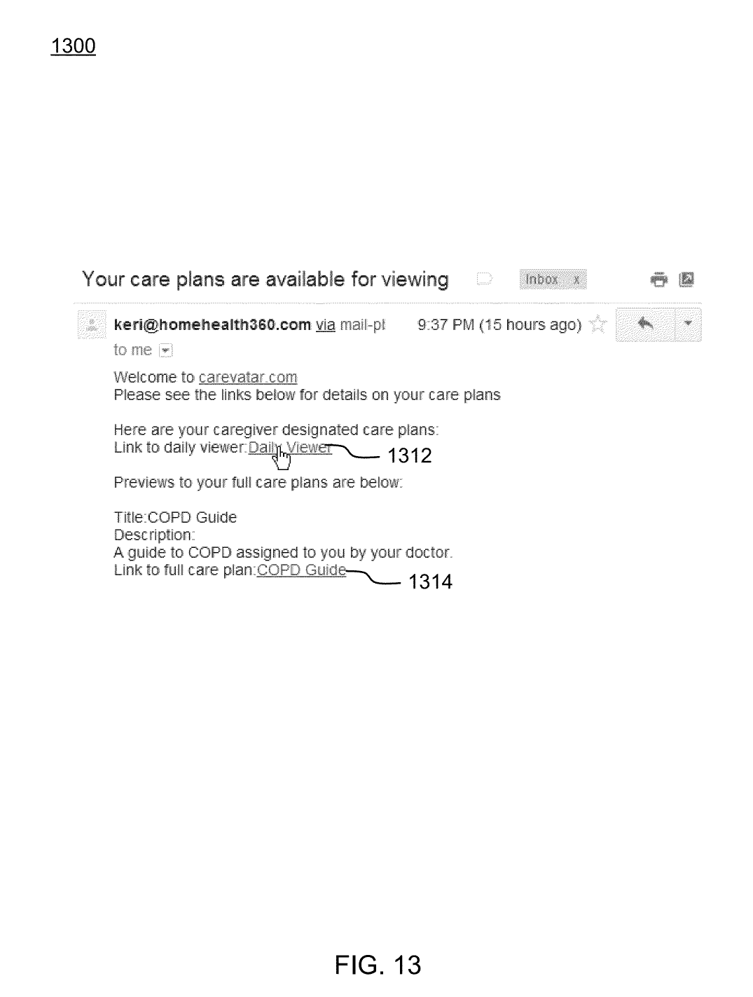

FIG. 12 illustrates an example physician geographical location map of a health care service application, according to example embodiments. The map interface 1200 may provide a specific doctor office location and a map integrated menu option 1210 used to invoke a location service when the patient is ready to find the doctor's location. FIG. 13 illustrates an example care plan selection interface of a health care service application, according to example embodiments. In FIG. 13, the user interface 1300 provides a message that includes hot links 1312 and 1314 to various content locations across the Internet or in a remote server.

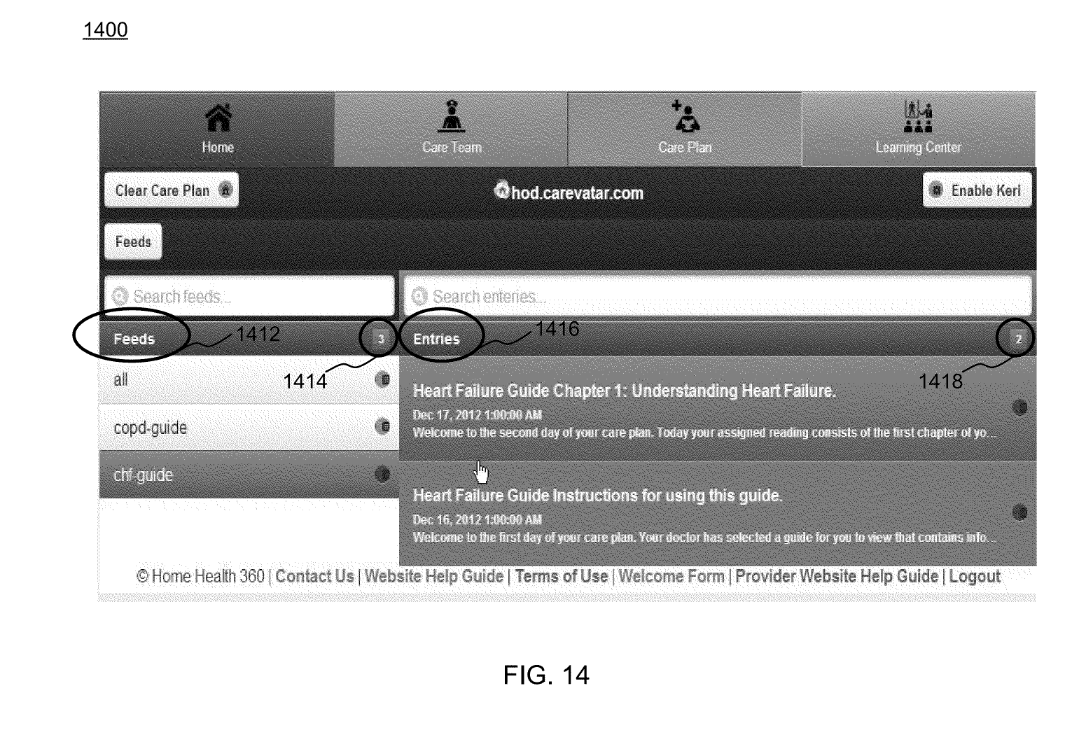

FIG. 14 illustrates an example condition content selection interface of a health care service application, according to example embodiments. In FIG. 14, the user interface 1400 is part of the home interface and provides a section of feeds 1412 that the user may access and a counter 1414 of a number of items the user must observe in order to comply with his or her current care plan requirements. The entries 1416 illustrate specific sub-topics that offer the user an opportunity to select a particular chapter or topic of interest based on a larger amount of information which may be required for the patient to read or understand. The counter 1418 provides an updated number of topics for a particular condition at a particular time.

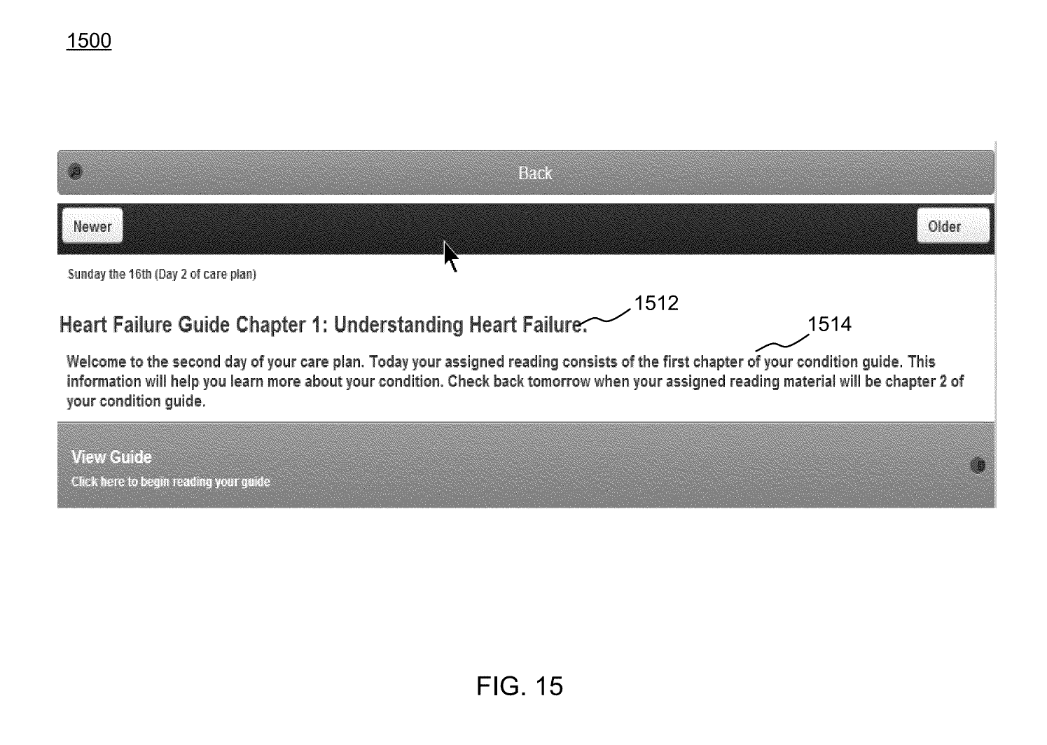

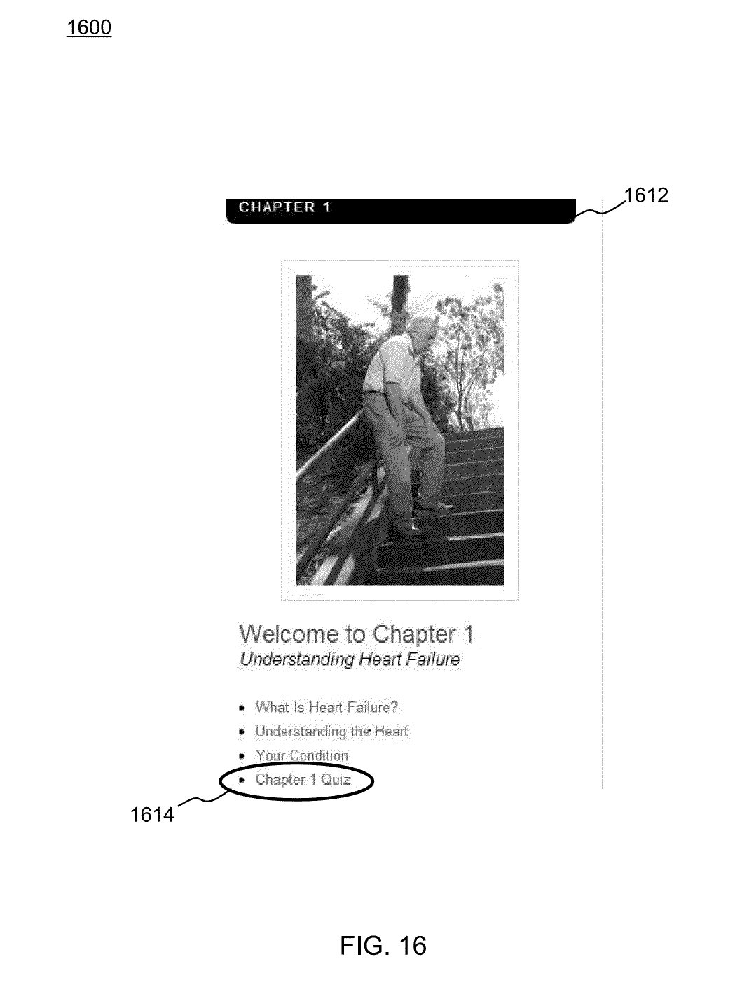

FIG. 15 illustrates an example health condition information portal of a health care service application, according to example embodiments. Referring to FIG. 15, the user interface 1500 includes a specific chapter guide 1512 as a link and a summary of information 1514 a user may observe prior to reading the content of the guide. FIG. 16 illustrates another example health condition information portal of a health care service application, according to example embodiments. In FIG. 16, the user interface 1600 illustrates a guide chapter 1612 and various links including a quiz 1614. The user may take the quiz which is scored and used to compile the user's compliance and update his or her health score to ensure compliance with the care plan application.

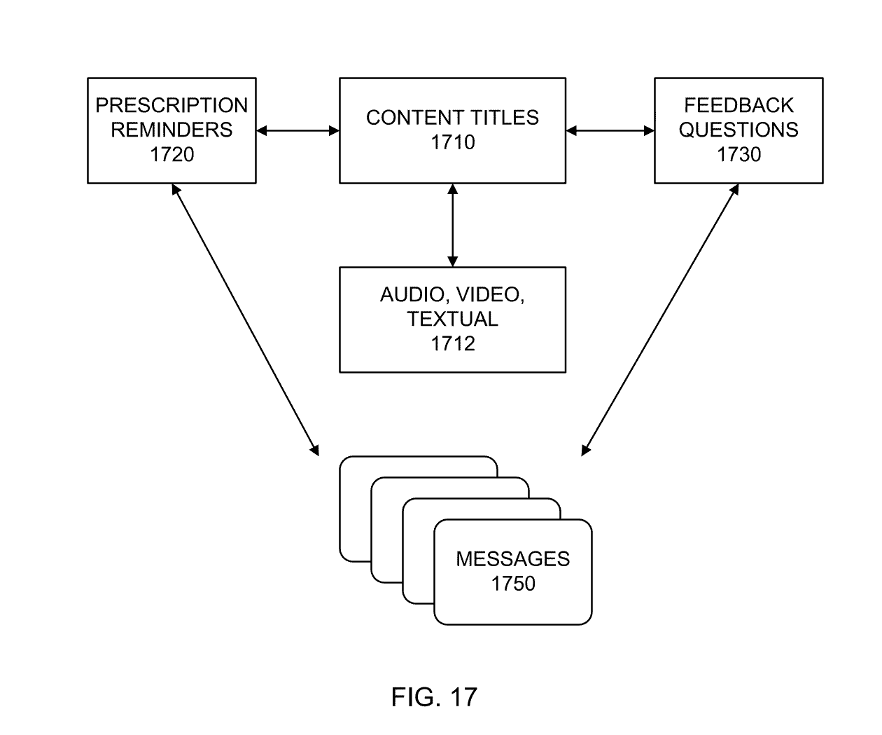

FIG. 17 illustrates an example health condition content sharing logic diagram of a health care service application, according to example embodiments. Referring to FIG. 17, the information sources may be remote servers, the cloud, third party servers, virtual nurse application servers, local servers, doctor's office servers, patient EMR record servers, etc. The content of the prescription reminders 1720, the condition content titles 1710 and the feedback and questions 1730 generated by the user may all be processed into messages that are shared among the servers and stored to update the patient's record and his or her present health score. The audio, video and/or textual information 1712 may be provided to the content titles that are needed to educate the user about his or her condition. The information may be shared, updated and delivered as messages 1750 to the user's computing device and to the various servers required to update and share the needed information.

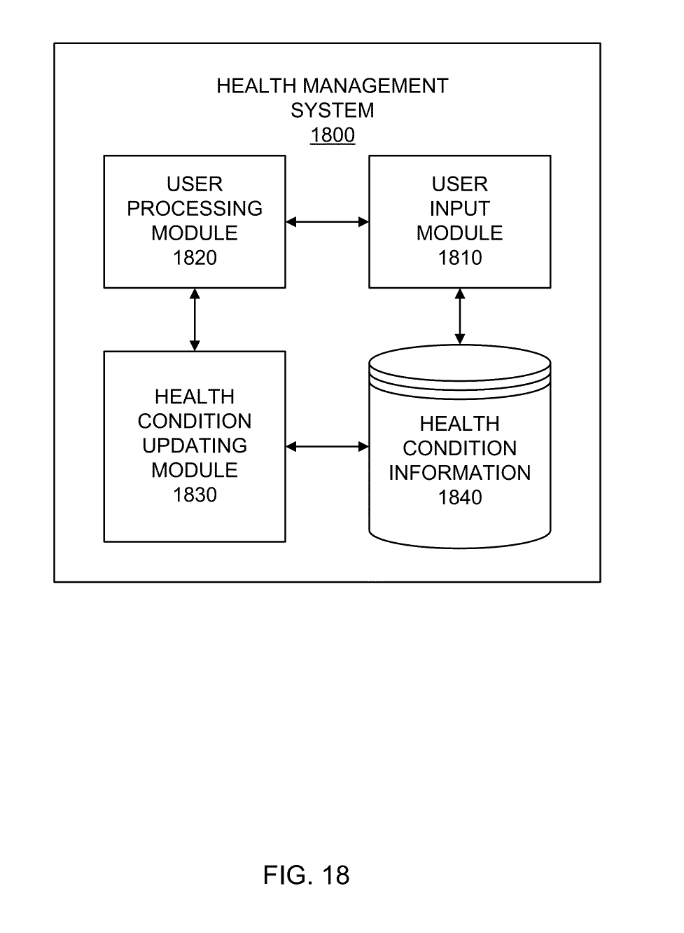

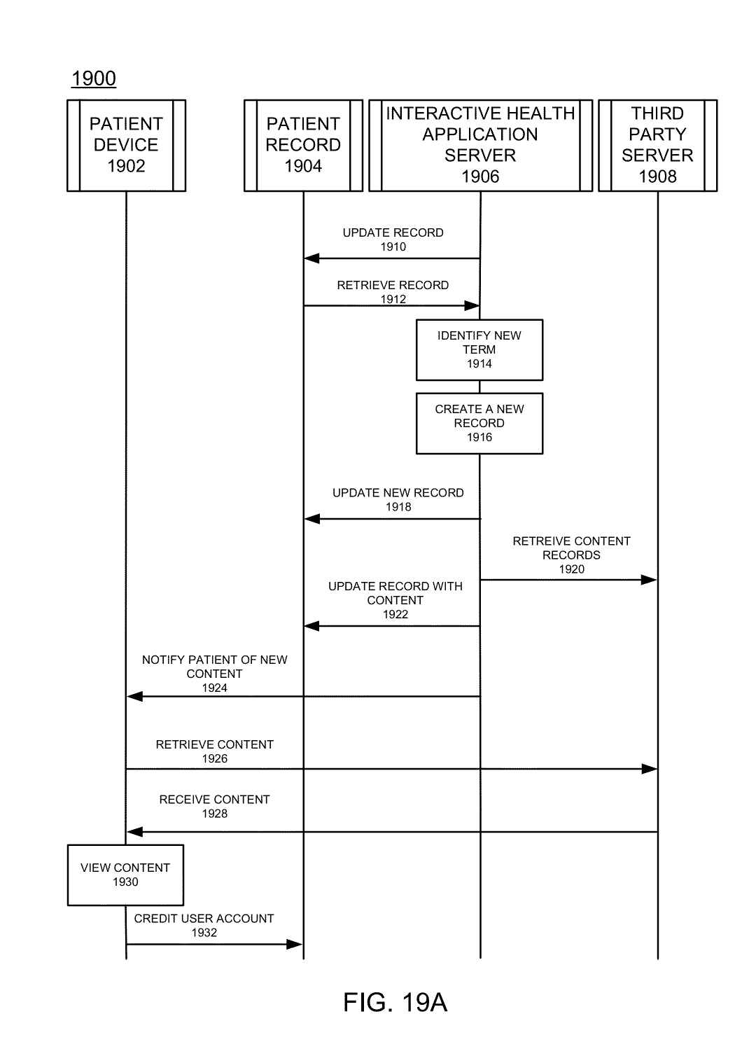

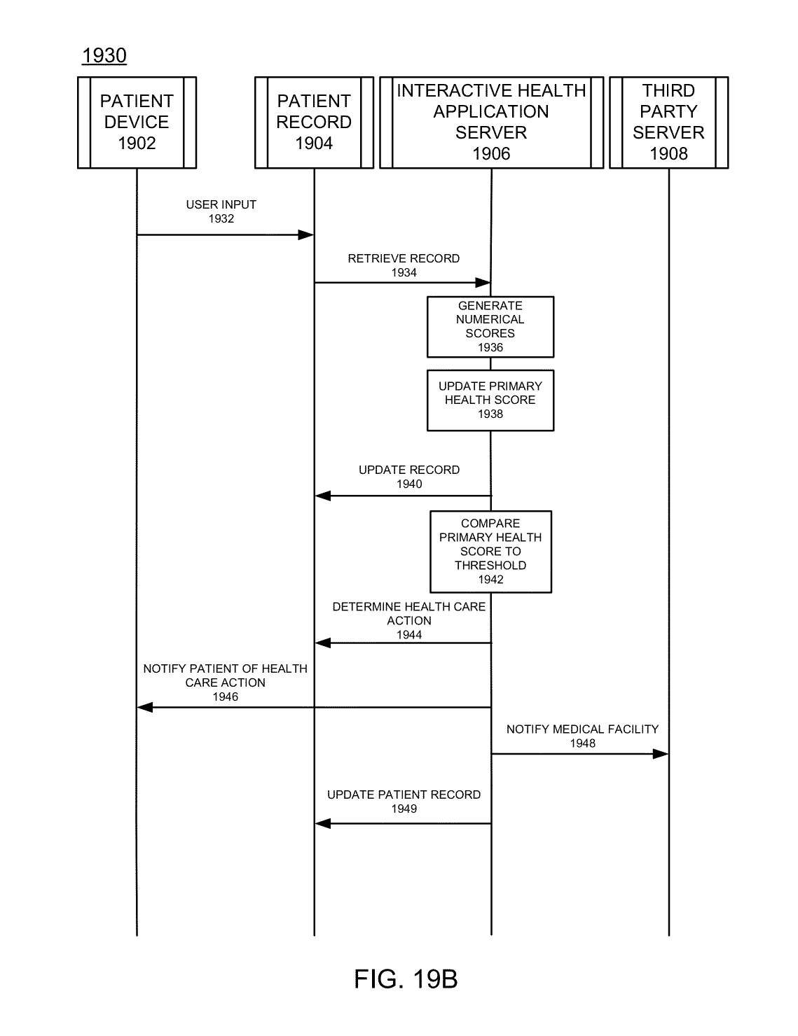

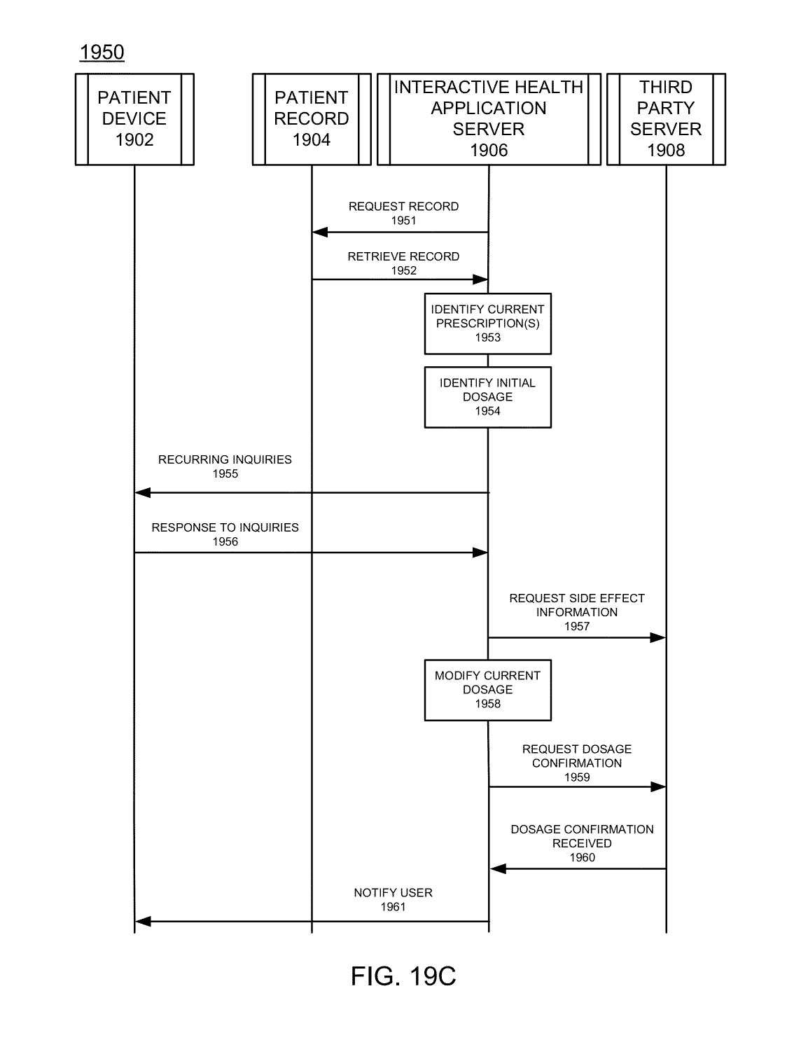

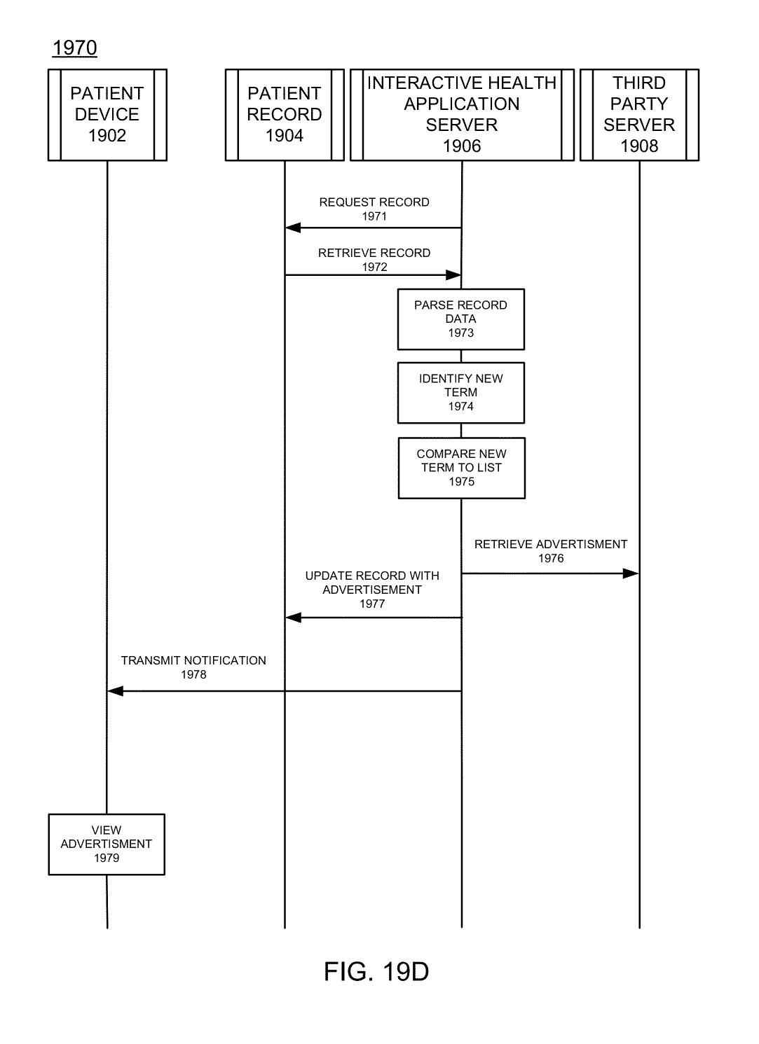

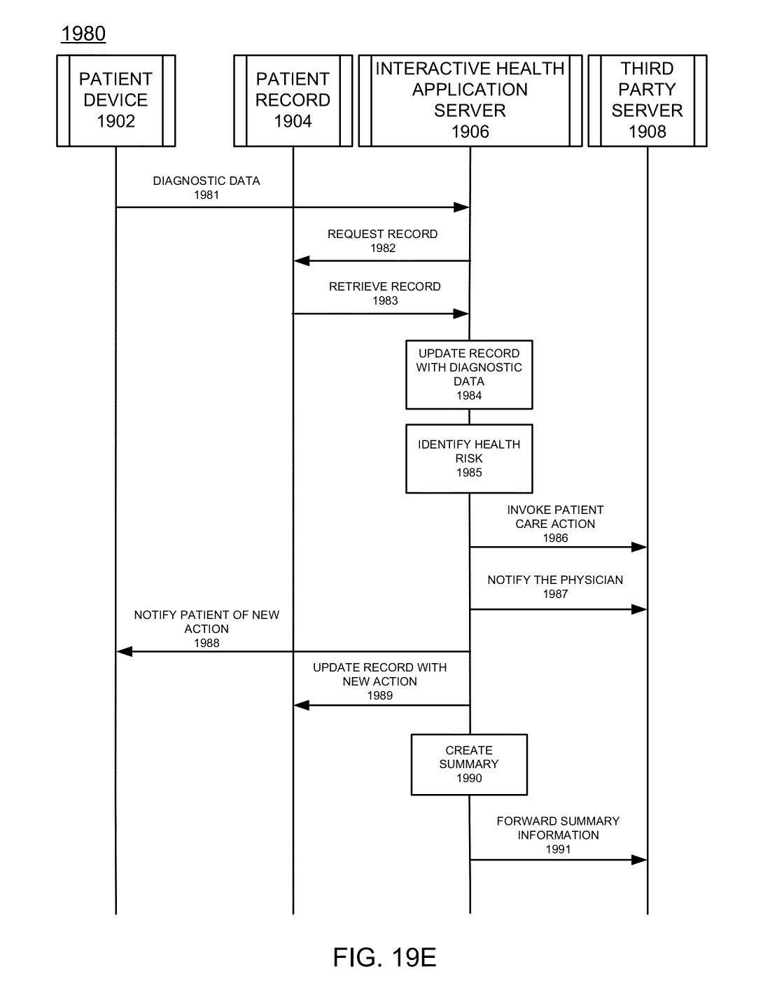

FIG. 18 illustrates an example system configuration 1800 according to example embodiments. Referring to FIG. 18, the user input module 1810 may receive user input data, quiz selections, questions, etc., which may be used to process the user's health score via the processing module 1820 and update the score accordingly via the conditioning update module 1830. The health condition information may be updated and stored at a remote database 1840 and retrieved to assist with user health scoring and patient requests. Any of the operations performed by the system configurations of FIGS. 19A-19E may be operated by such a processing system.

In one example method of operation, when a modification to a user's health care record is performed, the recorded modification may trigger an update to a user's care plan, which may include retrieving content titles for the user to watch. The trigger may be the addition of a new chronic condition which is detected from a parsing operation of keywords and grammars that are used to identify a particular condition and match it to a particular content title metatag for inclusion in the user's care plan of content to observe and learn.

In another example method of operation, the user may be assigned to fill prescriptions, take the medications, comment on pain, discomfort, improving conditions and other information, watch videos, read materials, take quizzes, provide vital sign information etc. The ongoing feedback may be used to generate a health care plan score. The score may be used to dictate the level of care or actions to take regarding the patient's health. The scores may be the basis for determining when a patient is permitted to make an appointment and not permitted to do so, readmission, no admission, emergency room, specialist, generate a note for the nurse, doctor, etc.

In another example method of operation, the method may include monitoring, administering and identifying medication dosages and results. A patient may need an increase or decrease in medicinal dosages and other related medicine. The feedback of the application allows a user to answer questions related to how the feel and how the medicine is working. This may automatically generate a suggestion to increase or lower a dosage amount of a particular medicine. The dosage modification may be a suggestion that is transferred to a doctor or nurse to accept, reject and/or modify. This procedure may be automated to reduce the need for the patient to contact the doctor directly and make an appointment for a simple prescription modification, especially one that could be anticipated by the doctor and setup as a threshold in the system that needs to be examined based on the user feedback.

In yet another example method of operation, the user may receive advertisements for medications and other medical treatments which are related to a chronic condition in the user's health records. The advertisements may be based on a number of variables and may be linked to the patient's conditions, age, weight, interests, etc. The advertisements may be part of a pool of potential advertisements which are accessed and applied to the user's interface for the virtual nurse application based on their identification tags and metatags.

In still yet another example method of operation, the user may provide ongoing vitals and other information that create an effective history or record. The user's health record may be integrated with a doctor's pre-evaluation and record prior to the patient showing up for health care appointments. The doctor may also modify a health plan or change medications depending on the progress experienced by the user via the ongoing medications.

FIG. 19A illustrates an example system configuration diagram according to example embodiments. Referring to FIG. 19A, the system configuration 1900 includes a patient device 1902 operated by the user and configured to interact with the user, receive user diagnostics and provide an interface for user communication and treatment efforts. The patient record 1904 is a data file or folder of virtual data records which can be accessed and updated to provide any necessary user treatment information. The application server 1906 provides the outsourced application (i.e., cloud source) which retrieves user information, processes user information and initiates certain actions to assist the user's health care. The third party server 1908 may be any information source utilized to provide information requested by the application 1906.

In one example method of operation, the patient record may be updated 1910 and retrieved 1912 to include any new treatment information since the last update. The record may be parsed or processed to identify the new term(s) 1914 and a new record or care plan can then be created 1916. Next, a number of content records to include in the user's health care management record can be selected based on the new terms (i.e., COPD manual, videos, etc.). The new record may be updated 1918 to reflect the changes and the content can be requested 1920 and received and updated 1922 into the patient record 1904 via access links or other virtual content sharing mechanisms. The patient device 1902 may receive notifications regarding the new content 1924. The patient may select a content title 1926 to view which then causes the patient device 1902 to retrieve the content from a third party server 1908 and receive the content 1928 accordingly. The content can be viewed 1930 and the patient record 1904 may be updated to reflect the user account 1932 having completed a required content title.

When the user's health care record is parsed to identify the at least one new term, any term identified may be compared to a predefined term included on a predefined list of terms each of which if invoked will cause a database retrieval and information loading operation to occur. A match may be identified between the new term and the one or more predefined terms included on the predefined list of terms which invokes health condition information being retrieved from a database. A pointer and/or a link may be written to the user's health care record which enables access to the health condition information. At least one requirement in the user's health care record can be created based on the health condition information, such as a requirement to view content as a condition precedent to receiving credit necessary to receive additional physician appointments, etc. The one requirement may be a requirement to view video content and audio content included in the health condition information being accessed or viewed on a computing device. The requirement may also be a test that must be performed based on the health condition information. A notification may be sent to inform the user of the updated health condition information, via email to a user email account, a short message service (SMS) message to a user mobile device and a voice call to the user mobile device.

Also, when creating a health care management record in the database responsive to an identified new term or condition may also include creating an application alert that initiates patient movement tracking by receiving periodic updates from a wearable device worn by the patient comprising at least one of a global positioning system tracker to monitor patient location and an accelerometer to monitor patient position. This configuration may be used for old or senile patients that require constant supervision and are likely to wander or fall. The trigger for this action may be a term, such as senile or memory loss, etc. The identified at least one new term is determined from the patient's health records which is accessed by the interactive health application via a login credential including at least one of patient's username and password. This information may be communicated to a healthcare professional by means a third party database, such as health management software including but not limited to EPIC Systems, PRACTICE FUSION, NEXTGEN Healthcare, ALLSCRIPTS, ATHENAHEALTH, ECLINICALWORKS, or the equivalent.

FIG. 19B illustrates an example system configuration diagram according to example embodiments. Referring to FIG. 19B, the user input 1932 may provide selection to inquiries or other input which may be received and used to generate user at least one numerical score corresponding to each user input selection. The scoring may be based on any of the various criteria being tracked for the user satisfaction of the current treatment plan. A user record may then be retrieved 1934 and incorporated with the numerical scores to calculate or update a master primary health score used to identify the user's current status, (e., 1-10), where a 9 or 10 could indicate the user requires immediate attention. The application 1906 may determine whether the user's primary health score is above or below at least one predetermined health threshold, which would create a trigger action to occur.

A trigger term may be any one of various physical parameters subjective or objective health measurements whose measurement is updated in the patient's records and compared against medical personnel determined thresholds. A trigger action is any one of various possible actions taken in response to a trigger term triggering a medical personnel determined threshold value for a given subjective or objective physical parameter. A notification alert can then be created to invoke a health care action if the user's primary health score exceeds or undercuts the at least one predetermined health threshold. The application server 1906 may receive and generate a number of numerical scores 1936 in each category and update the user's primary health score 1938 which is used as the basis for most trigger actions, although individual numerical scores can be designated as triggers as well depending on the importance of such data or the user's specific profile information and health condition. The user's record 1940 can be updated to reflect the changes and the primary health score will in turn be compared to the established thresholds 1942 to determine if an action should be taken 1944. The patient is then notified of the health care action resulting from the trigger action 1946 and the appropriate facility can be notified 1948 to setup an appointment, call emergency services, notify family members, have the doctor's office call the patient, etc. All changes and actions taken can be updated in the patient record for future reference 1949.

The user input selections from the various inquiries may provide receiving a number of numerical scores over a predefined period of time established by the user's care team. Also, the various numerical scores can be identified and determined as to whether they exceed the predetermined health threshold and a resulting action may include a medical office appointment and/or a physician notification being created and sent responsive to the acceptable health threshold being exceeded. Also, the numerical score of each user input selection may correspond to a number of inquiries provided to the user to determine a number of different health indicators which are received and combined in a weighted function to identify the user's primary health score. Those scores may be based on at least one of categories, such as tiredness, drowsiness, nausea, lack of appetite, shortness of breath, depression, anxiety, pain, anxiety, dehydration, fatigue, blood pressure, heart rate, body temperature, pO2 (oxygen saturation), blood alcohol content (BAC), depression, xerostomia, constipation, wound healing, alopecia, appetite, exhaustion, forced expiratory volume (FEV1), well-being, and glucose level. Each inquiry category may be summed together as a composite score which is identified as either good, acceptable or poor. The present user condition status may be elevated if the composite score is acceptable or poor and as a result, a vital sign monitor associated with the user device may be enacted to confirm the user's present user condition status as a trigger action (poor status=automatic blood pressure check). The vital sign may be measured via a hardware sensory attachment to the user device.

FIG. 19C illustrates an example system configuration diagram according to example embodiments. Referring to FIG. 19C, the system configuration 1950 may provide an example method including identifying at least one medical prescription currently associated with a user's health care management record 1953 after requesting the record 1951 and receiving the record 1952. The initial dosage requirement can be identified for the one or more medical prescriptions 1954 and a series of recurring inquiries in the user's health care management record may be generated and sent 1955 to the user device 1902. A number of responses to the recurring inquiries are received 1956 and a decision is made to determine whether to create a dosage modification based on the responses. Side effect information may be requested 1957 from the information source 1908 to provide diligence and assurance the medication regiment is valid and safe.

The status for each of the responses are identified and compared to known side effects of the at least one medical prescription to determine the present dosage is one or correct, too high, too low, and/or negatively interacting with another medication. The response statuses may include a dry mouth, dizziness, drowsiness, fatigue, increased heart rate, skin irritation, loss of appetite, memory loss, problems with coordination, tinnitus, syncope, swelling of hands or feet, decreased heart rate, constipation, diarrhea, anxiety, blurred vision, upset stomach, vomiting, headache, muscle aches and pains, and nausea. If the dosage must be changed 1958 a notification is created and transmitted to the user's physician of record 1959 and a confirmation may then be received in due course that the dosage modification is acceptable 1960. The notification may then be transmitted to a registered user account and to the user device with instructions 1961. The dosage modification may include a change to at least one of dosage frequency, dosage quantity, route of administration, and medication brand. Any patient medications are identified and audited to conclude if a conflict may occur along with a patient allergy to one or more prescribed medications. The responses to inquiries may be answered via an automated sensor that identifies at least one of dosage frequency and dose quantity, and transmits corresponding dosage information either wirelessly or via a wired sensor transmitter to a wireless protocol enabled mobile device operated by the user.

FIG. 19D illustrates an example system configuration diagram according to example embodiments. Referring to FIG. 19D, the example system configuration 1970 may include identifying a modification to a user's health care record stored in a database by requesting the record 1971 and receiving the record 1971. The data record may be parsed 1973 and the terms identified are then used to determine if new terms are present since a previous audit procedure. Those new terms 1974 may be the basis for retrieving an advertisement associated with a predefined list of associated terms which match the at least one new term 1975. Such terms may be conditions the user is experiencing, such as diabetes, COPD, congestive heart disease, etc., and the terms may be associated with specific drug advertisements which can be, matched, retrieved 1976 and associated 1977 with a user's dashboard application interface. The advertisement may be direct target function that creates a message 1978 in the user's health care record with access to the advertisement.

Other factors may include identifying the user's age or age range and any chronic conditions present in the user's health care record to select an appropriate advertisement selection algorithm that is based on age range, at least one present health condition, other health conditions and other known user information. Also, the physical devices assigned to the user are also candidate information for comparing to the advertisement tags or metadata content, such as wheel chairs, walker, oxygen tanks, scooters, worn hardware and traction gear, etc. The comparing of metadata from at least one advertisement data file may be performed so the advertisement and information tags associated with the advertisement may be compared to the user's age and the chronic conditions so selecting the advertisement based on a match between the metadata and the user's age and chronic conditions can be performed for optimization of the selection process. The advertisement may be sent to a registered user device via at least one of web link, an image banner or video banner on a homepage of a user interactive health record application, a short message service (SMS) message, a phone call, an email and a video, the user can then view the advertisement 1979 and may receive credit necessary for user health application compliance. The at least one new term could be a physical patient characteristic identified from the user's health care record including but not limited to pain, nausea, anxiety, dehydration, fatigue, blood pressure, heart rate, body temperature, depression, xerostomia, constipation, wound healing, alopecia, appetite, exhaustion, tiredness, drowsiness, shortness of breath, forced expiratory volume, and glucose level. Also, the advertisement could be customized based on the at least one new term, and transmitted for display on a registered user device. The user input could be identified in an online social network account instead and one or more keywords from the user input that match the predefined list of associated terms associated with the advertisement could be identified as used to retrieve the advertisement. The advertisement could be linked with the user's social network account and displayed on the user's social network homepage or “wall”. The user's age can be defined as an age range and also the chronic conditions present in the user's health care record are part of the advertisement selection algorithm. This may include comparing metadata from the advertisement data file including the advertisement and information tags associated with the advertisement to the user's age range and the chronic conditions, and the advertisement will then be selected based on a match between the metadata and the user's age range and the chronic conditions.

FIG. 19E illustrates an example system configuration diagram according to example embodiments. Referring to FIG. 19E, the system configuration 1980 may include receiving at least one recurring user health diagnostic 1981 at a server 1906 which then requests 1982 and receives the user record 1983 so the record can be updated 1984 with the user health diagnostic data on a recurring basis to generate a history. The at least one recurring user health diagnostic may be stored in a user patient data record of the server 1906. If necessary, a health diagnostic history summary can be generated based on the recurring user health diagnostic and the user patient data record can be updated to include the health diagnostic history.

The user's present health risks 1985 could be identified based on the user health diagnostic data as an automated database screening and matching function to invoke a patient care response action 1986 responsive to identifying the at least one health risk factor or a pre-diagnosis pending a physician confirmation 1987. Invoking a patient care response action may include performing scheduling a patient care appointment, scheduling patient tests, scheduling patient vaccinations, modifying the user's current exercise plan, modifying the user's nutrition plan, modifying the user's medication, and modifying the user's health care personnel team. Also, identifying the health risk factor based on the at least one recurring user health diagnostic may include invoking a treatment plan for the at least one health risk factor, and transmitting a notification to the user's registered physician to confirm the treatment plan. Then, receiving confirmation from the user's registered physician may invoke modifying the user's current medication plan by adding at least one new medication and removing at least one current medication from the user's current medication plan. The user is notified 1988 and the record is updated accordingly 1989. The recurring data is useful for creating a summary 1990, such as a chart or graph of user progress or lack thereof, which can be forwarded to the physician of record 1991.

Receiving the recurring user health diagnostic may include receiving user vital sign information from a sensor configured with a user computing device. The user vital sign information may include at least one of blood pressure, heart rate, respiratory rate, pupil size, glucose level, body temperature, oxygen saturation, electrocardiogram (ECG), and respiratory capacity.

According to example embodiments, the homepage of the application website contains links to the rest of the areas of the site and some controls that will affect your browsing experience. An overview of the controls available to the user may include a region at the top of the screen that contains buttons that easily allow you to access all the main areas of the site. This region is available throughout most areas of the site and it contains the following buttons, ‘Home:’ a link to the home page. This link may be used when viewing other areas of the site to return to the front page. ‘Care Team:’ this area of the site contains bios, contact information and driving directions related to the health care providers that are available. ‘Care Plan:’ this area of the site contains doctors assigned to the care plan. If the user has not navigated to this site through the link received in a welcome email, or by a bookmark which was made from the link that was sent to an email, then the care plans will not be available for viewing. ‘Learning Center:’ this area of the site contains a library of learning resources available to everyone. The virtual nurse or ‘Keri’ is a virtual patient ambassador who will provide information about the pages of the site and also will read aloud the contents of all the informational pages of the site. On the home page she will speak about options for browsing the site.

In general, the user will be able to view the care plans that the healthcare provider has assigned. A customized care plan is a combination of different RSS feeds that have been selected by the healthcare provider. This area of the site should be checked regularly as new messages (called entries) will appear daily with new information for the user to read. If no feeds or messages (entries) are available on this page then the user may return to the welcome email click on the link daily feed viewer link in to view care plans.

In the user's access options, by using a URL that includes the patient's care plan name and date that the patient starts on the care plan, informational pages and videos related to the patient's condition may be provided in an RSS feed which is displayed in a plugin section of an ATMAIL function. The RSS feeds will have an alternate HTML view to display data in a printable format. One of the RSS feeds will be an aggregation of all members of the feed in order to view all the data at once. The information displayed to patient is timed based on when they started the care plan. The interface allows users to view whole care plans which is useful for making a print out to take home with the user or just items that are ready to be viewed within the RSS feed based on a current day.

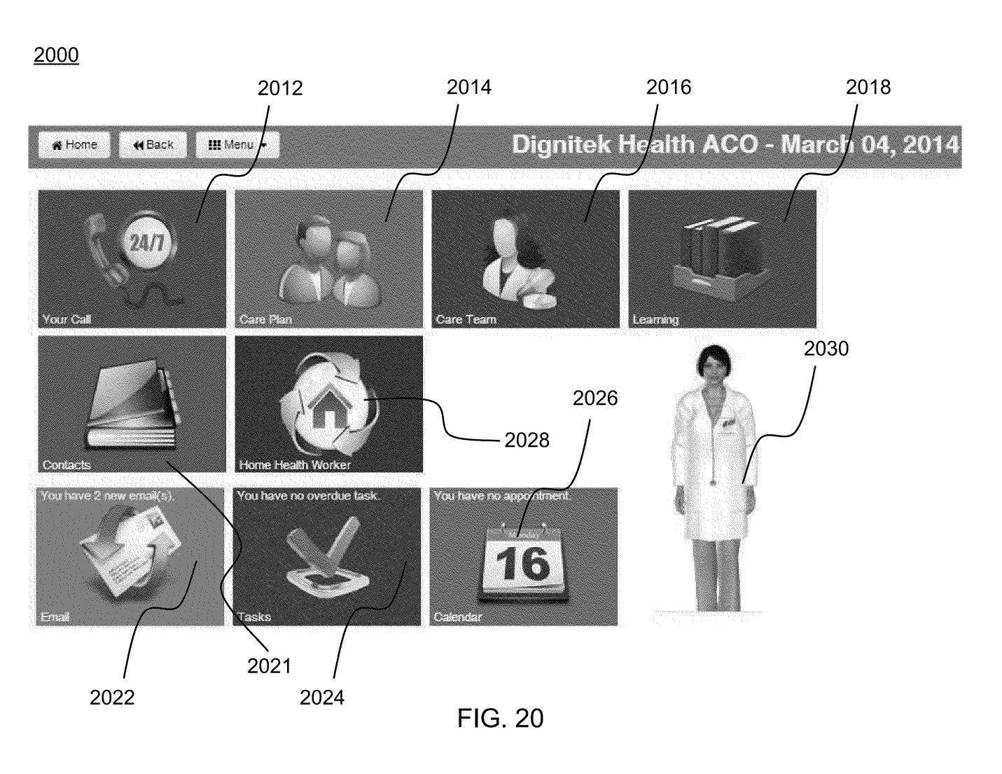

FIG. 20 illustrates an example user interface screenshot of the interactive health application for a patient according to example embodiments. Referring to FIG. 20, the user interface 2000 has a variety of options for a patient to select including a digital/virtual nurse aid 2030 which assists the patient by talking and prompting the user to perform certain tasks. Options available to the patient may include a call option 2012 to contact immediate assistance, this option may be setup for emergency personnel depending on the patient's condition and the severity of his or her conditions and/or age. The care plan 2014 offers the various different items available for a user to select and interact with in order to further the health care process. The care team 2016 provides access to the various users and affiliates of the patient for contact purposes, such as telephone number, email, etc. The learning center 2018 is the source of information available to the user depending on the conditions being experienced. The home health worker 2028 is the provider of home health services, the contacts 2021 are all the numbers and emails, etc. of all interested parties. The emails 2022 provide a notification system for the user to read new and updated messages, the task section 2024 are the immediate tasks to be performed on any given day. The appointments 2026 are also a reminder of upcoming events that need to be identified and addressed.

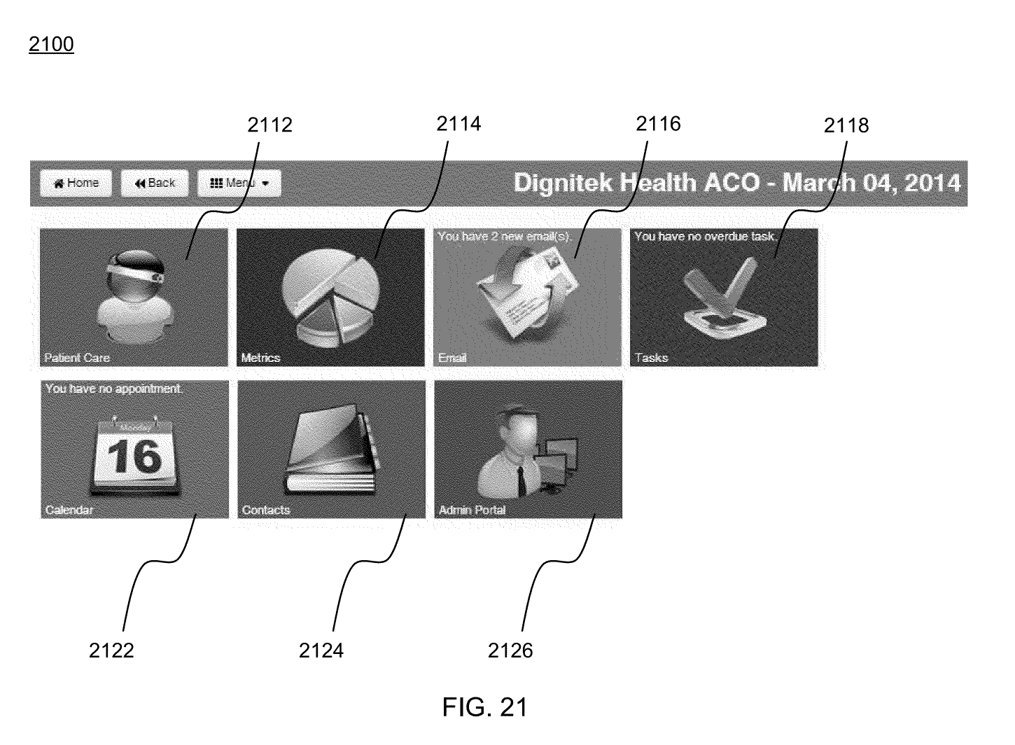

FIG. 21 illustrates an example user interface screenshot of the interactive health application for a physician according to example embodiments. In this example, the interface 2100 includes a patient care option 2112 to identify the patients who are under the physician's control for this particular application. The metrics 2114 is where the data can be observed for each patient along with updates and suggested courses of action, the emails 2116 provides messages from patients or other third parties, the tasks 2118 are the tasks outstanding for the physician, the calendar 2122 provides access to the daily schedule, the contacts 2124 provide access to the contacts of the physician and the admin portal 2126 is where the physician can receive assistance with the application.

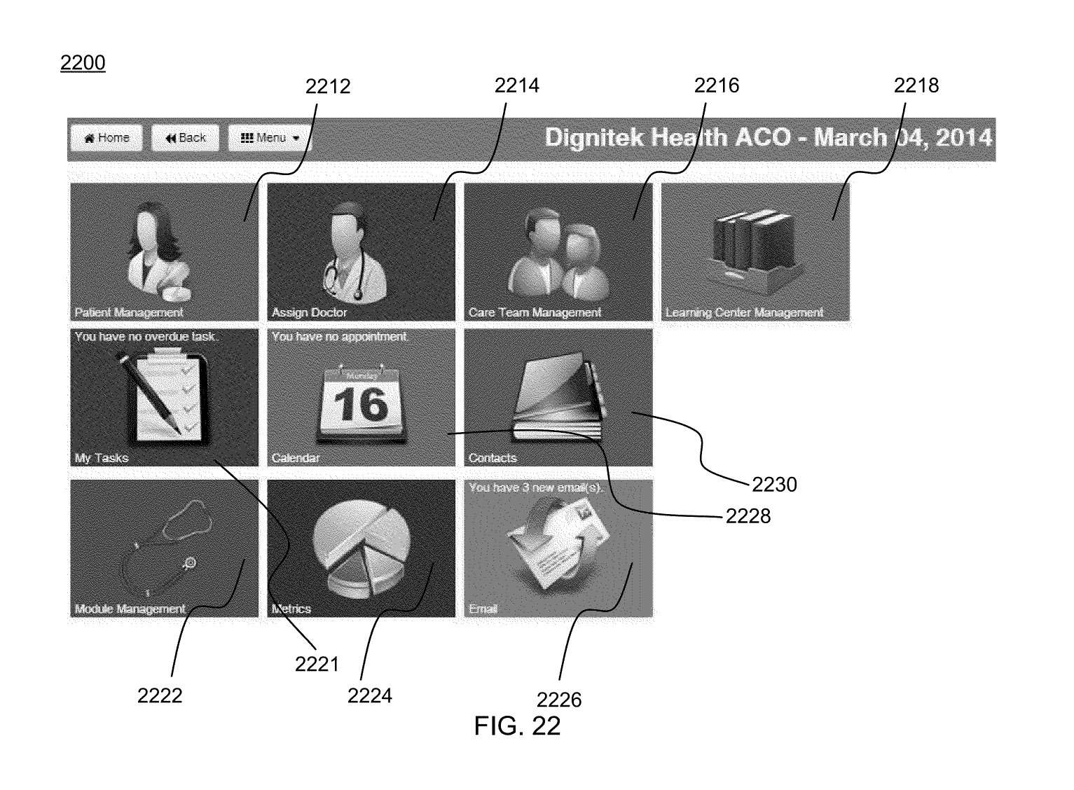

FIG. 22 illustrates an example user interface screenshot of the interactive health application for an administrator according to example embodiments. The administrator interface 2200 includes options such as a patient management tab 2212 to identify the patients, the available physicians 2214 which can be paired with a patient, the care team management 2216 is where assistants can be paired with the patients, the learning center 2218 is where the learning materials can be assigned to the patients, the tasks 2221 are where the administrator can view his or her tasks, the calendar 2228 offers upcoming events and deadlines, the contacts 2230 are the parties of interest and their contact information, the module management 2222 is the master management tab to setup a patient's care plan, the metrics 2224 are the figures and data of the patients and the emails 2226 are the administrator's emails for easy access.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

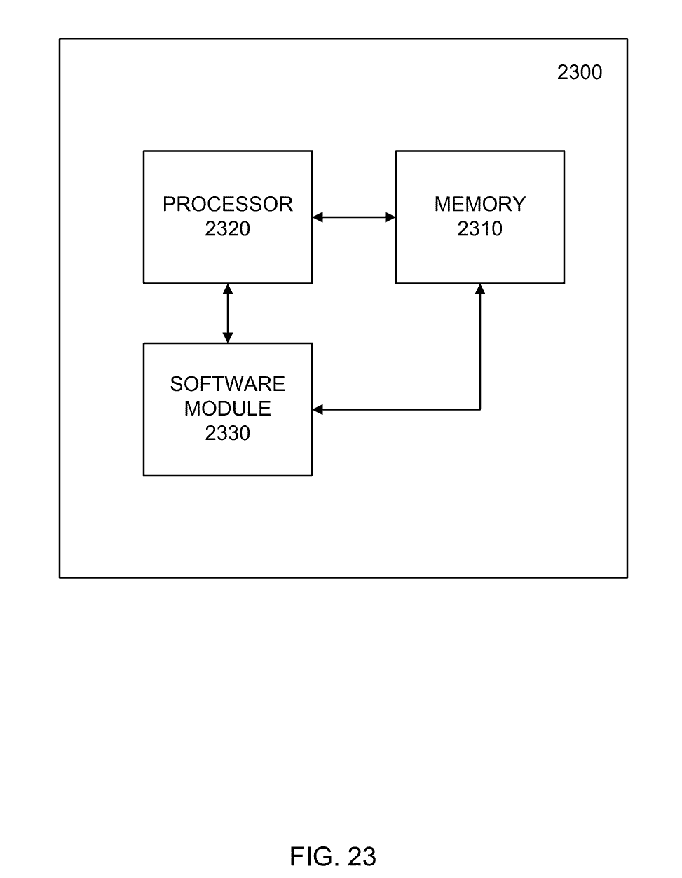

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 23 illustrates an example network element 2300, which may represent any of the above-described network components.

As illustrated in FIG. 23, a memory 2310 and a processor 2320 may be discrete components of the network entity 2300 that are used to execute an application or set of operations. The application may be coded in software in a computer language understood by the processor 2320, and stored in a computer readable medium, such as, the memory 2310. The computer readable medium may be a non-transitory computer readable medium that includes tangible hardware components in addition to software stored in memory. Furthermore, a software module 2330 may be another discrete entity that is part of the network entity 2300, and which contains software instructions that may be executed by the processor 2320. In addition to the above noted components of the network entity 2300, the network entity 2300 may also have a transmitter and receiver pair configured to receive and transmit communication signals (not shown).

While preferred embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

What is claimed is:

1. A method comprising:
receiving at least one recurring user health diagnostic at a server configured to store user health records from a remote user computing device configured to receive and update user health diagnostic data of a user on a recurring basis;
storing the at least one recurring user health diagnostic in a user patient data record of the server; and
generating a health diagnostic history summary based on the at least one recurring user health diagnostic and updating the user patient data record to include the health diagnostic history.

2. The method of claim 1, further comprising:
identifying at least one health risk factor based on the user health diagnostic data; and
invoking a patient care response action responsive to identifying the at least one health risk factor.

3. The method of claim 1, wherein invoking a patient care response action responsive to identifying the at least one health risk factor comprises performing at least one of scheduling a patient care appointment, scheduling patient tests, scheduling patient vaccinations, modifying the user's current exercise plan, modifying the user's nutrition plan, modifying the user's medication, and modifying the user's health care personnel team.

4. The method of claim 1, further comprising:
identifying at least one health risk factor based on the at least one recurring user health diagnostic;
invoking a treatment plan for the at least one health risk factor; and
transmitting a notification to the user's registered physician to confirm the treatment plan.

5. The method of claim 4, further comprising:
receiving confirmation from the user's registered physician; and
modifying the user's current medication plan by performing at least one of adding at least one new medication and removing at least one current medication from the user's current medication plan.

6. The method of claim 1, wherein receiving the at least one recurring user health diagnostic comprises receiving user vital sign information from a sensor configured with a user computing device.

7. The method of claim 1, wherein the user vital sign information comprises at least one of blood pressure, heart rate, respiratory rate, pupil size, glucose level, body temperature, oxygen saturation, electrocardiogram (ECG), and respiratory capacity.

8. The method of claim 1, further comprising:
updating the user patient data record to include the health diagnostic history summary responsive to a patient appointment being scheduled at a corresponding physician facility.

9. An apparatus comprising:
a receiver configured to receive at least one recurring user health diagnostic at a server configured to store user health records from a remote user computing device configured to receive and update user health diagnostic data of a user on a recurring basis;
a memory configured to store the at least one recurring user health diagnostic in a user patient data record of the server; and
a processor configured to generate a health diagnostic history summary based on the at least one recurring user health diagnostic and updating the user patient data record to include the health diagnostic history.

10. The apparatus of claim 9, wherein the processor is further configured to identify at least one health risk factor based on the user health diagnostic data, and invoke a patient care response action responsive to identifying the at least one health risk factor.

11. The apparatus of claim 9, wherein the processor invokes a patient care response action responsive to identifying the at least one health risk factor by further being configured to perform at least one of scheduling a patient care appointment, scheduling patient tests, scheduling patient vaccinations, modifying the user's current exercise plan, modifying the user's nutrition plan, modifying the user's medication, and modifying the user's health care personnel team.

12. The apparatus of claim 8, wherein the processor is further configured to identify at least one health risk factor based on the at least one recurring user health diagnostic, invoke a treatment plan for the at least one health risk factor, and the apparatus also includes a transmitter configured to transmit a notification to the user's registered physician to confirm the treatment plan.

13. The apparatus of claim 12, wherein the receiver is further configured to receive confirmation from the user's registered physician, and the processor is further configured to modify the user's current medication plan by performing at least one of adding at least one new medication and removing at least one current medication from the user's current medication plan.

14. The apparatus of claim 9, wherein the receiver receives the at least one recurring user health diagnostic buy also receiving user vital sign information from a sensor configured with a user computing device.

15. The apparatus of claim 9, wherein the user vital sign information comprises at least one of blood pressure, heart rate, respiratory rate, pupil size, glucose level, body temperature, oxygen saturation, electrocardiogram (ECG), and respiratory capacity.

16. The apparatus of claim 9, wherein the processor is further configured to update the user patient data record to include the health diagnostic history summary responsive to a patient appointment being scheduled at a corresponding physician facility.

17. A non-transitory computer readable storage medium configured to store instructions that when executed cause a processor to perform:
receiving at least one recurring user health diagnostic at a server configured to store user health records from a remote user computing device configured to receive and update user health diagnostic data of a user on a recurring basis;
storing the at least one recurring user health diagnostic in a user patient data record of the server; and
generating a health diagnostic history summary based on the at least one recurring user health diagnostic and updating the user patient data record to include the health diagnostic history.

18. The non-transitory computer readable storage medium of claim 15, wherein the processor is further configured to perform:
identifying at least one health risk factor based on the user health diagnostic data; and
invoking a patient care response action responsive to identifying the at least one health risk factor.

19. The non-transitory computer readable storage medium of claim 15, wherein invoking a patient care response action responsive to identifying the at least one health risk factor comprises performing at least one of scheduling a patient care appointment, scheduling patient tests, scheduling patient vaccinations, modifying the user's current exercise plan, modifying the user's nutrition plan, modifying the user's medication, and modifying the user's health care personnel team.

20. The non-transitory computer readable storage medium of claim 15, wherein the processor is further configured to perform:
identifying at least one health risk factor based on the at least one recurring user health diagnostic;
invoking a treatment plan for the at least one health risk factor; and
transmitting a notification to the user's registered physician to confirm the treatment plan.
